(19) United States
(12) Patent Application Publication
(10) Pub. No.: US 2026/0329804 A1
(43) Pub. Date: Oct. 22, 2026

(54) APPARATUS AND METHOD FOR SEQUENCING READING OF DATA IN A RECONFIGURABLE DATA PROCESSOR

(71) Applicant: SambaNova Systems, Inc., Palo Alto, CA (US)

(72) Inventors: David Brian JACKSON, Dana Point, CA (US); Shashank VIJAYA RANGA, Fremont, CA (US); Raghu PRABHAKAR, San Jose, CA (US)

(73) Assignee: SambaNova Systems, Inc., Palo Alto, CA (US)

(21) Appl. No.: 19/333,306

(22) Filed: Sep. 18, 2025

Related U.S. Application Data
(60) Provisional application No. 63/790,967, filed on Apr. 18, 2025.

(51) Int. Cl. G06F 15/78; G06F 9/52

(52) U.S. Cl. CPC G06F 15/7892; G06F 9/52

(57) ABSTRACT

In one implementation, a configurable unit of a coarse grained reconfigurable array is configured to receive data of a first data group. A first circuit of the configurable unit is selectively configurable to count data received by the configurable unit. The first circuit inhibits reading of data in the second data group until all of the data of the first data group is received.

### PRIORITY CLAIM TO PRIOR PROVISIONAL FILINGS

This application claims priority to prior filed Provisional Application no. 63/790,967 entitled “APPARATUS AND METHOD FOR SEQUENCING READING OF DATA IN A RECONFIGURABLE DATA PROCESSOR” filed on Apr. 18, 2025, having a docket number of SBNV1218USP01, and having common inventors David Brian Jackson et al. which is hereby incorporated herein by reference.

### CROSS-REFERENCE TO RELATED DOCUMENTS AND APPLICATIONS

This application is related to the following published documents:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018;
U.S. patent application Ser. No. 18/218,562, published as US 2024/0020261, entitled “Peer-To-Peer Route Through In A Reconfigurable Computing System,” filed on Jul. 5, 2023;
U.S. patent application Ser. No. 18/383,718, published as US 2024/0073129, entitled “Peer-To-Peer communication between Reconfigurable Dataflow Units,” filed Oct. 25, 2023;
U.S. patent application Ser. No. 16/239,252, now U.S. Pat. No. 10,698,853, entitled “Virtualization of a Reconfigurable Data Processor,” filed Jan. 3, 2019;
U.S. patent application Ser. No. 18/107,613, published as US 2023/0251839, entitled “Head Of Line Blocking Mitigation In A Reconfigurable Data Processor,” filed on Feb. 9, 2023, and
U.S. patent application Ser. No. 18/107,690, published as US 2023/0251993, entitled “Two-Level Arbitration in a Reconfigurable Processor,” filed on Feb. 9, 2023.

### BACKGROUND

### Technical Field

The technology disclosed relates to improved management of communication between elements of a reconfigurable data processor and relates to processing instructions and moving data in a coarse grain reconfigurable processor.

### Context

Coarse grain reconfigurable architectures exhibit far superior performance over conventional architectures, such as field programmable gate arrays (FPGAs) as they provide the capability to execute applications as nested dataflow pipelines. Maximizing the utilization of units in the coarse grain reconfigurable architectures assists in performing useful computations in coarse grain reconfigurable architectures. During operation within the coarse grain reconfigurable architecture, there can be multiple reconfigurable units functioning as source units that spread data across multiple receivers or destination units. The data may be passed through intermediate storage units before reaching the destination units. In some cases data, including instructions, may get out of order. For example, the intermediate storage units may store the data in a different order than the order used by the source units. The out of order data may cause race conditions within the system or may cause the system to have to go through many iterations of examining the data before getting the data reordered. Thus, this can result in, among other things, degraded system performance.

### BRIEF DESCRIPTION OF THE DRAWINGS

FIG. 1 illustrates portions of an example of an implementation of a coarse grain reconfigurable system that includes a coarse grain reconfigurable processor;

FIG. 2 illustrates portions of an example of a computer that may have an implementation that may be substantially the same as at least a portion of the host of FIG. 1;

FIG. 3 illustrates a simplified block diagram of portions of an implementation of a coarse grain reconfigurable processor that may have an implementation that may be an alternate implementation of the coarse grain reconfigurable processor of FIG. 1;

FIG. 4 illustrates an example of portions of an implementation of a coarse grain reconfigurable array that includes an array of coarse grain reconfigurable units interconnected with connected an array level network;

FIG. 5 illustrates a simplified block diagram of an example of an implementation of a coarse grain reconfigurable array that may be an implementation of at least a portion of the coarse grain reconfigurable array of FIG. 4;

FIG. 6 illustrates a simplified block diagram of an example of an implementation of a configurable pattern memory unit that may be an implementation of any one or more of the configurable units illustrated in FIGS. 4-5;

FIG. 7 illustrates a simplified block diagram of an example of an implementation of a semaphore generation circuit that may be an implementation of portions of the configurable pattern memory unit of FIG. 6;

FIG. 8 illustrates a simplified block diagram of an example of an implementation of a semaphore control circuit including a semaphore priority circuit that may be an implementation of a semaphore control circuit of FIG. 6;

FIG. 9 graphically illustrates a simplified block diagram of a portion of the coarse grain reconfigurable array of FIG. 5 having source units sending one or more data groups to destination units;

FIG. 10 illustrates a simplified block diagram of an example of an implementation of a coarse grain reconfigurable array that may be an implementation of at least a portion of the coarse grain reconfigurable array of FIGS. 4-5; and

FIG. 11 includes a flowchart illustrating in a general manner some steps in an operation to sequence of reading of data from a memory of a coarse grain reconfigurable unit.

### DETAILED DESCRIPTION

As used herein, the phrase “one of” should be interpreted to mean exactly any one of the listed items. For example, the phrase “one of A, B, and C” should be interpreted to mean any of: only A, only B, or only C

As used herein, the phrases “at least one of” and “one or more of” should be interpreted to mean one or more items. For example, the phrase “at least one of A, B, or C” or the phrase “one or more of A, B, or C” should be interpreted to mean any number of the items of A, B, and/or C. The phrase “at least one of A, B, and C” means at least one of A and at least one of B and at least one of C.

Unless otherwise specified, the use of ordinal adjectives “first”, “second”, “third”, etc., to describe an object, merely refers to different instances or classes of the object and does not imply any ranking or sequence. The terms first, second, third and the like in the claims or/and in the Detailed Description, as used in a portion of a name of an element, are used for distinguishing between similar elements and not necessarily for describing a sequence, either temporally, spatially, in ranking or in any other manner. It is to be understood that the terms so used are interchangeable under appropriate circumstances and that the implementations or embodiments described herein are capable of operation in other sequences than described or illustrated herein.

The terms “comprising” and “consisting of” have different meanings in this document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be indirect through galvanic, capacitive, inductive, electromagnetic, optical, or through any other electrical element or process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item or circuit elements can be configured to perform the task even when the unit/circuit/component is not currently on or active. In general, the circuitry that forms the structure corresponding to “configured to” may include hardware circuits, and may further be controlled by switches, logical or analog electronics, fuses, bond wires, metal masks, firmware, and/or software. Similarly, various items may be described as performing a task or tasks, for convenience in the description. Such descriptions should be interpreted as including the phrase configured to. Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. Section 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The words “during”, “while”, and “when” as used herein relating to circuit operation are not exact terms that mean an action takes place instantly upon an initiating action but that there may be some small but reasonable delay(s), such as various propagation delays, between the reaction that is initiated by the initial action. Additionally, the term “while” means that a certain action occurs at least within some portion of a duration of the initiating action. When used in reference to a state of a signal, the term “asserted” means an active state of the signal and the term “negated” means an inactive state of the signal. The actual voltage value or logic state (such as a “1” or a “0”) of the signal depends on whether positive or negative logic is used. Thus, asserted can be either a high voltage or a high logic or a low voltage or low logic depending on whether positive or negative logic is used and negated may be either a low voltage or low state or a high voltage or high logic depending on whether positive or negative logic is used. Herein, a positive logic convention is used, but those skilled in the art understand that a negative logic convention could also be used.

The terms “close”, “near”, and “about” refer to being within minus or plus 10% of an indicated value, unless explicitly specified otherwise. The use of the word “approximately” or “substantially” means that a value of an element has a parameter that is expected to be close to a stated value or position. However, as is well known in the art there are always minor variances that prevent the values or positions from being exactly as stated. It is well established in the art that variances of up to at least ten per cent (10%) (and up to twenty per cent (20%) for some elements including semiconductor doping concentrations and shapes of sidewalls/distances of doped regions) are reasonable variances from the ideal goal of exactly as described.

For simplicity and clarity of the illustration(s), elements in the figures are not necessarily to scale, some of the elements may be exaggerated for illustrative purposes, and the same reference numbers in different figures denote the same elements, unless stated otherwise. Cross hatched regions or cross-hatching in the drawings is used merely to assist in distinguishing boundaries of different regions and does not imply any type of materials. Additionally, descriptions and details of well-known steps and elements may be omitted for simplicity of the description. Neither the figures nor the Detailed Description are intended to limit the scope as claimed. Instead, they merely represent examples of different implementations.

Reference to “one embodiment” or “an embodiment” or an “implementation” means that a particular feature, structure, or characteristic described in connection with the embodiment or implementation is included in at least one implementation. Thus, appearances of the phrases “in one implementation” or “in an implementation” in various places throughout this specification are not necessarily all referring to the same implementation, but in some cases it may. Furthermore, the particular features, structures or characteristics may be combined in any suitable manner and in a wide variety of different implementations, as would be apparent to one of ordinary skill in the art, in one or more implementations.

The embodiments or implementations illustrated and described hereinafter may have implementations and/or may be practiced in the absence of any element which is not specifically disclosed herein.

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor (CGRP), an architecture (see CGRA), an array, or a unit in an array (CGRU). This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units (CGRUs).
CGR Array or ACGRU—an array of CGR units (ACGRUs), coupled with each other through an array-level network (ALN). ACGRU may be coupled with external elements via a top-level network (TLN). A CGR array can physically implement the nodes and edges of a Graph.
Compiler—a translator that processes statements written in a programming language to machine language instructions for a computer processor. A compiler may include multiple stages to operate in multiple steps. Each stage may create or update an intermediate representation (IR) of the translated statements. For the purposes of this disclosure, an assembler that generates configuration data for a CGR processor from low-level so-called assembly language code can also be referred to as a compiler.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
Dataflow Graph or Graph—a computation graph that includes one or more loops that may be nested, and wherein nodes can send messages to nodes in earlier layers to control the dataflow between the layers. For example, a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
CGR unit or CGRU—a circuit that can be configured and reconfigured to locally either or both of store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that includes one or more loops that may be nested, and wherein nodes can send messages to nodes in earlier layers to control the dataflow between the layers.
Graph—a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph or graph that includes a producer operator providing its output as an input to a consumer operator. Metapipelines may be nested, that is, producer operators and consumer operators may include other metapipelines.
ML—machine learning.
Multi-Port Memory—A multi-port memory can include one or more arrays of memory cells that allow for concurrent access to the memory from more than one access port. This can be accomplished in several ways, depending on the implementation, including, but not limited to, a multi-port memory array, multiple banks of memory that allow access to the different banks of memory simultaneously, time multiplexing access to the memory cells from the access port, or a combination thereof.
PCU—pattern compute unit—a compute unit that can be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL—reconfigurable dataflow unit (RDU) abstract intermediate language.
SIMD—single-instruction multiple-data—an arithmetic logic unit (ALU) that simultaneously performs a single programmable operation on multiple data elements delivering multiple output results.
TLN—top-level network.

### IMPLEMENTATIONS

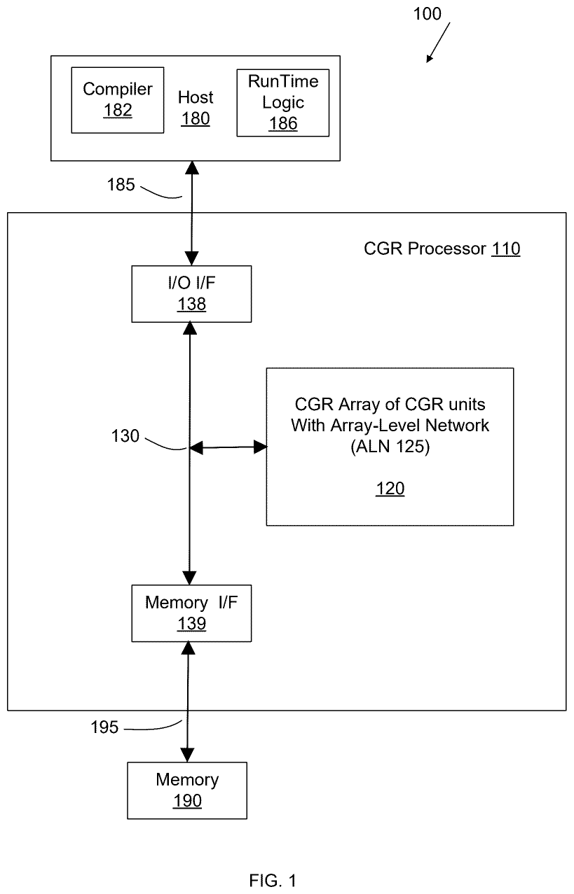

FIG. 1 is a block diagram illustration of an example of an implementation of a system 100 including a CGR processor (CGRP) 110, a host 180, and a memory 190. CGR processor (CGRP) 110 has a coarse-grained reconfigurable architecture (CGRA) and includes an array of CGR units (ACGRUs) 120 such as a CGR array. CGR processor (CGRP) 110 further includes an I/O interface (I/F) 138, and a memory interface (I/F) 139. Array of CGR units (ACGRUs) 120 is coupled with I/O interface (I/F) 138 and memory interface (I/F) 139 via a top-level network (TLN) 130 that may include a data bus. Host 180 communicates with I/O interface 138 via system data bus 185, and memory interface 139 communicates with memory 190 via memory bus 195. Array of CGR units (ACGRUs) 120 may further include compute units, memory units, and/or fused compute-memory units that are connected with an array-level network (ALN) 125 to provide the circuitry for execution of a Graph, such as for example a computation graph or a dataflow graph, that may have been derived from a high-level program with user algorithms and functions. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, execution of the Graph(s) may involve using multiple units of CGR processor (CGRP) 110. In some implementations, CGR processor (CGRP) 110 may include one or more ICs. In other implementations, a single IC may span multiple coarsely reconfigurable data processors. In further implementations, CGR processor (CGRP) 110 may include one or more units of array of CGR units (ACGRUs) 120.

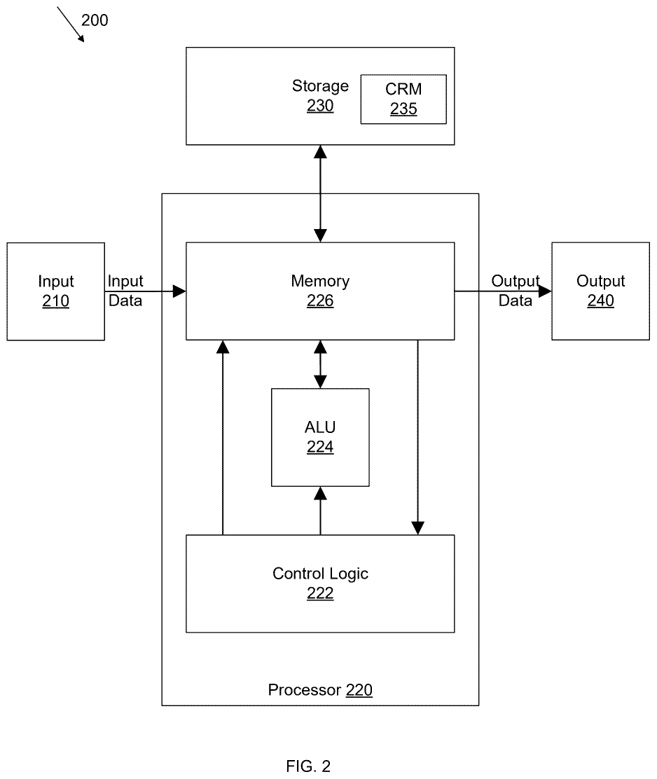

Host 180 may be, or may include, a computer such as further described with reference to FIG. 2. Host 180 runs runtime logic 189, as further referenced herein, and may also be used to run computer programs, such as a compiler 187 as described herein. In some implementations, compiler 187 may run on a computer 200 as described in FIG. 2, but separate from host 180 and unconnected to CGR processor (CGRP) 110.

CGR processor (CGRP) 110 may accomplish computational tasks by executing a configuration file (for example, a PEF file). For the purposes of this description, a configuration file corresponds to a dataflow graph, or a translation of a dataflow graph, and may further include initialization data. A compiler, such as for example compiler 182, compiles the high-level program to provide the configuration file. In some implementations described herein, a CGR array or a ACGRU is configured by programming one or more configuration stores in the CGR units within the array 120 with all or parts of the configuration file. A single configuration store may be at the level of the CGR processor (CGRP) or the CGR array, or a CGR unit of the CGR array may include an individual configuration store. The configuration file may include configuration data for the CGR array and CGR units in the CGR array, and link the computation graph to the CGR array. Execution of the configuration file by CGR processor (CGRP) 110 causes the CGR array(s) to implement the user algorithms and functions in the dataflow graph.

CGR processor 110 can be implemented on a single integrated circuit die or on a multichip module (MCM). An IC can be packaged in a single chip module or a multichip module. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding or flip-chip bonding.

A computing system implementing aspects of the current disclosure may include coarse-grained reconfigurable processor (CGRP) 110 and host processor 180 coupled to the CGR processor (CGRP) 110 and including runtime logic 186 configured to provide configuration data to CGR processor (CGRP) 110 to load into the configuration store of a CGR unit (CGRU) in CGR array 120.

FIG. 2 illustrates portions of a block diagram of an example of a computer 200 that may have an implementation that may be substantially the same as at least a portion of host 180 (FIG. 1). Computer 200 may include an input device 210, a processor 220, a storage device 230, and an output device 240. Although the example computer 200 is drawn with a single processor, other implementations may have multiple processors. Input device 210 may comprise a mouse, a keyboard, a sensor, an input port (for example, a universal serial bus (USB) port), and any other input device known in the art. Output device 240 may comprise a monitor, printer, and any other output device known in the art. Furthermore, part or all of input device 210 and output device 240 may be combined in a network interface, such as a Peripheral Component Interconnect Express (PCIe) interface suitable for communicating with CGR processor (CGRP) 110. Input device 210 is coupled with processor 220 to provide input data, which an implementation may store in memory 226.

Processor 220 is coupled with output device 240 to provide output data from memory 226 and computations from processor 220 to output device 240. Processor 220 further includes control logic 222, operable to control memory 226 and arithmetic and logic unit (ALU) 224, and to receive program and configuration data from memory 226. Control logic 222 further controls exchange of data between memory 226 and storage device 230.

Memory 226 typically comprises memory with fast access, such as static random-access memory (SRAM), whereas storage device 230 typically comprises memory with slow access, such as dynamic random-access memory (DRAM), flash memory, magnetic disks, optical disks, and any other memory type known in the art. At least a part of the memory in storage device 230 may include a non-transitory computer-readable medium (CRM 235), such as used for storing computer programs and/or configuration files. The memory 226 may also or alternatively include a non-transitory computer-readable medium for storing computer programs and/or configuration files. The computer programs and/or configuration files may configure the host computer and/or a CGR processor coupled to the host computer to perform methods and/or other aspects of the present disclosure.

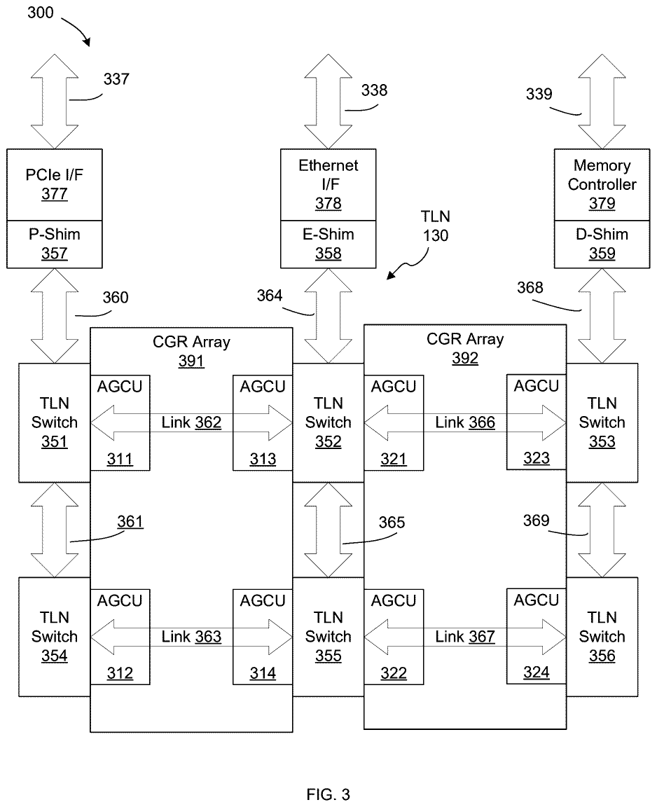

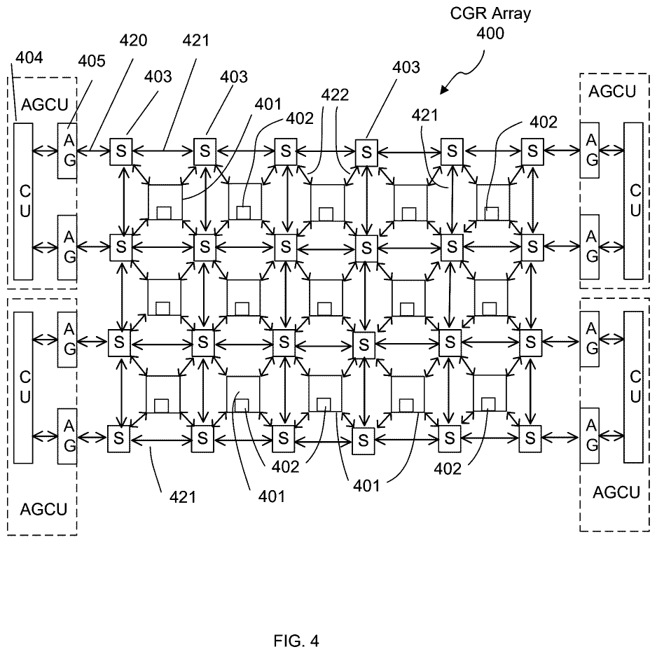

FIG. 3 illustrates a simplified block diagram of an example of portions of an implementation of a CGRP 300 that may have an implementation that may be an alternate implementation of CGRP 110. CGRP 300 has a CGRA (Coarse Grain Reconfigurable Architecture). In this example, CGRP 300 has two CGR arrays (Array1 391, Array2 392), although other implementations can have any number of arrays or tiles, including a single tile. As will be seen further in the description of FIG. 4, CGR array 391 and 392 each comprise an array of configurable units (ACGRUs) connected by an array-level network, such as for example ALN 125 (FIG. 1). Each of CGR arrays 391 and 392 has one or more AGCUs (Address Generation and Coalescing Units) 311-314 and 321-324. The AGCUs may have an implementation in which the AGCUs are configurable. The AGCUs are nodes on both top level network 130 and on array-level networks within their respective CGR array 391 and 392 and include resources for routing data among nodes on top level network 130 and nodes on the array-level network in each CGR array 391 and 392.

CGR arrays 391 and 392 are coupled to top level network (TLN) 130 that may have implementations that includes switches 351-356 and links 360-369 that allow for communication between elements of Array1 391, elements of Array2 392, and shims to other functions of the CGR processor 110 including P-Shims 357, 358 and M-Shim 359. Other functions of the CGR processor (CGRP) 110 may connect to TLN 130 in different implementations, such as additional shims to additional and or different input/output (I/O) interfaces and memory controllers, and other chip logic such as CSRs, configuration controllers, or other functions. Data may travel in packets between the devices (including switches 351-356) on links 360-369 of TLN 130. For example, top level switches 351 and 352 are connected by a link 362, top level switches 351 and P-Shim 357 are connected by a link 360, top level switches 351 and 354 are connected by a link 361, and top level switch 353 and D-Shim 359 are connected by a link 368.

TLN 130 is a packet-switched mesh network using an array of switches 351-356 for communication between agents. Any routing strategy can be used on TLN 130, depending on the implementation, but some implementations may arrange the various components of TLN 130 in a grid and use a row, column addressing scheme for the various components. Such implementations may then route a packet first vertically to the designated row, and then horizontally to the designated destination. Other implementations may use other network topologies and/or routing strategies for TLN 130.

P-Shims 257, 258 provide an interface between TLN 130 and PCIe Interfaces 377, 378 which connect to external communication links 337, 338 which may form part of communication links such as system data bus 185 as shown in FIG. 1. While two P-Shims 357, 358 with PCIe interfaces 377, 378 and associated PCIe links 337, 338 are shown, implementations can have any number of P-Shims and associated PCIe interfaces and links. A D-Shim 359 provides an interface to a memory controller 379 which has a DDR interface 339 and can connect to memory such as the memory 190 of FIG. 1. While only one D-Shim 359 is shown, implementations can have any number of D-Shims and associated memory controllers and memory interfaces. Different implementations may include memory controllers for other types of memory, such as a flash memory controller and/or a high-bandwidth memory (HBM) controller. The interfaces for Shims 357-359 include resources for routing data among nodes on the top level network (TLN) 130 and external devices, such as high-capacity memory, host processors, other CGRA processors, FPGA devices and so on, that are connected to the interfaces for Shims 357-359.

As explained earlier, in the description of system 100 (FIG. 1) each CGR processor can include an array of CGR units disposed in a configurable interconnect (array level network), and the configuration file defines a data flow graph including functions in the configurable units and links between the functions in the configurable interconnect. In this manner the configurable units act as sources or destinations of data used by other configurable units providing functional nodes of the graph. Such systems can use external data processing resources not implemented using the configurable array and interconnect, including memory and a processor executing a runtime program, as sources or sinks of data used in the graph.

One of the AGCUs in each CGR array in this example is configured to be a master AGCU (MAGCU), which includes an array configuration load/unload controller for the CGR array. The MAGCU1 311 includes a configuration load/unload controller for CGR array 391, and MAGCU2 321 includes a configuration load/unload controller for CGR array 392. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

FIG. 4 illustrates an example of portions of an implementation of a CGR array 400, including an array of CGR units (ACGRUs) connected in an ALN. A data processing operation implemented by a CGR array configuration, such as CGR array 400, may comprise multiple Graphs or subgraphs specifying data processing operations that are distributed among and executed by corresponding CGRUs. CGR array 400 includes one or more types of CGR units (CGRUs) 401, such as for example FCMUs, PMUs, PCUs, memory units, and/or compute units. In some implementations, some of CGRUs 401 may be PCUs or PMUs. In other implementations, some of CGRUs 401 may be an FCMU or memory units and compute units, arranged in a checkerboard pattern. In yet other implementations, the CGRUs may be arranged in different patterns. For examples of the functions of these types of CGRUs, see Prabhakar et al., “Plasticine: A Reconfigurable Architecture for Parallel Patterns”, ISCA 2017, Jun. 24-28, 2017, Toronto, ON, Canada.

For some transactions within CGR array 400, an initiating CGRU may be referred to as a source, requestor, initiator, or producer CGRU depending on the type of transaction. The source CGRU may initiate various types of transactions to various resources in a remote CGRU. The remote CGRU may be referred to as a destination, or sink, or consumer, or target CGRU. In some cases, the source CGRU may receive various responses from the destination CGRU.

CGRUs 401 may include a configuration store/logic circuit (Cfg) 402 that includes a set of storage and/or control logic, such as for example registers or flip-flops, that store configuration data. As will be seen further hereinafter, the configuration data may represent a setup and/or control sequence that may facilitate executing a Graph. Cfg 402 may also include status information about the CGRU usable to track progress for execution of a Graph or sub-graph. Cfg 402 may further include the source of operands, and the network parameters for the input and output interfaces.

A configuration file for Cfg 402 may include configuration data representing an initial configuration, or starting state of one or more of the CGRUs, or internal elements of the CGRU, that executes a graph or other high-level program with user algorithms and functions. Program load is the process of initializing the configuration store (Cfg) with the configuration file for configuring the configuration stores in the CGR array based on the configuration data to facilitate the CGRUs executing the graph or other the high-level program. Program load may also require loading memory units and/or PMUs.

The ALN of CGR array 400 includes switch units or switches(S) 403, and AGCUs that each may include two address generators (AG) 405 and a shared coalescing unit (CU) 404. Switches(S) 403 are connected among themselves via interconnects 421 and are also connected to a CGRU 401 with interconnects 422. Switches(S) 403 may be coupled with address generators (AG) 405 via interconnects 420. In some implementations, communication channels can be configured as end-to-end connections, and switches 403 may be CGRUs. In other implementations, switches route data via the available links based on address information in packet headers, and communication channels establish as and when needed.

The ALN includes one or more kinds of physical data buses, for example a chunk-level vector bus (e.g., 512 bits wide to transmit 512 bits of data), a word-level scalar bus (e.g., 32 bits wide to transmit 32 bits of data), and a control bus. For instance, interconnects 421 between two switches may include a vector bus interconnect with a word wide bus width, for example 512 bits wide, and a scalar bus interconnect with a bus with a scalar word width, for example 32 bits wide, along with a control bus. The control bus can comprise physical lines separate from the data buses in some implementations. In other implementations, the control bus can be implemented using the same physical lines with a separate protocol or in a time-sharing procedure. A control bus can comprise a configurable interconnect that carries multiple control bits on multiple signal routes designated by configuration bits in the CGRU's configuration file in the configuration store (such as in Cfg 402).

Physical data buses may differ in the granularity of data being transferred. In one implementation, a vector bus can carry a transmission that includes 16 channels of 32-bit floating-point data or 32 channels of 16-bit floating-point data (i.e., 512 bits) of data as its payload. An implementation of a scalar bus can have a 32-bit payload and carry scalar operands or control information. The control bus can carry control handshakes such as tokens and other signals. The vector and scalar buses can be packet-switched, where the packets may include headers that indicate a destination of each packet and other information such as sequence numbers that can be used to reassemble a file when the packets are received out of order. Each packet header can also include a destination identifier that identifies the spatial coordinates of the destination switch unit (e.g., the row and column in the array), and an interface identifier that identifies the interface on the destination switch (e.g., North, South, East, West, etc.) used to reach the destination unit.

Each CGRU 401 may have four ports (as illustrated) to interface with switches 403, or any other number of ports suitable for an ALN. Each port may be suitable for receiving and transmitting data, or a port may be suitable for only receiving or only transmitting data.

A switch(S) 403 may have eight interfaces. North, South, East, and West interfaces of a switch unit may be used for links between switch units using interconnects 421. Northeast, Southeast, Northwest, and Southwest interfaces of a switch unit may each be used to make a link with a CGRU 401 using one of interconnects 422. Two switches 403 in each CGR array quadrant may have links to an AGCU using interconnects 420. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more interconnects between the switch units to the CGRUs using the vector bus and vector interface(s) of the one or more switch units on the ALN. A CGR array may comprise at least a part of CGR array 400, and any number of other CGR arrays coupled with CGR array 400.

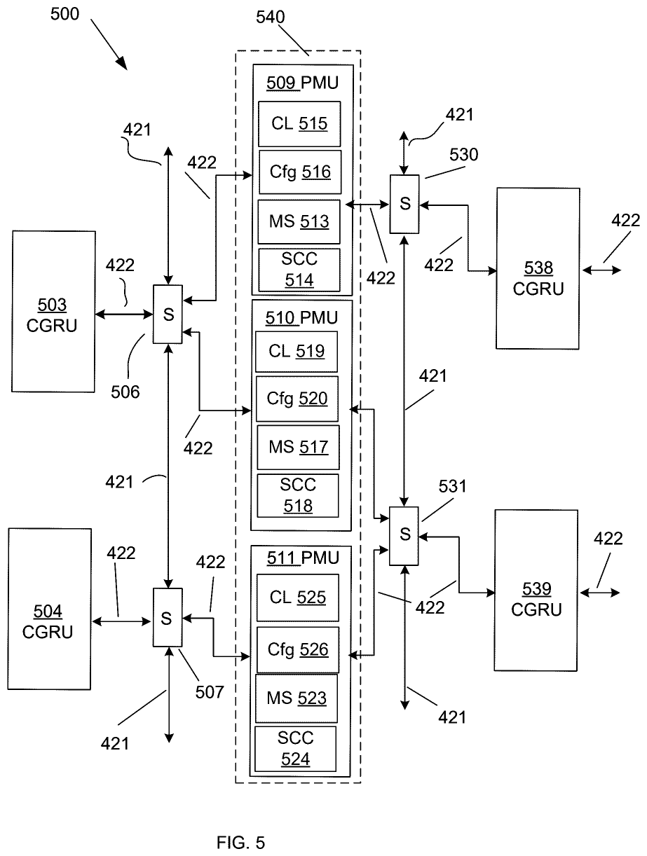

FIG. 5 illustrates a simplified block diagram of an example of portions of an implementation of a CGR array 500 that may be an implementation of at least a portion of CGR array 400 (FIG. 4). CGR array 500 may be configured to execute a Graph or sub-graph to implement a defined function. CGR array 500 includes CGRUs 503-504 and 538-539 along with PMUs 509, 510, and 511. ALN switches(S) 506, 507, 530, and 531 of CGR array 500 may be implementations of ALN switches(S) 403 that are described in the description of FIG. 4. CGRUs 503-504 and 538-539 may be any one of the CGRU types described hereinbefore or in the description of FIG. 4. During the execution of a Graph or sub-graph, the source CGRUs, such as for example CGRU 503-504, may send a group of data, a data group, to different ones of PUMs 509, 510, and 511. The data group may include packets of vector data or packets of scalar data or other types of data. For example, during execution of the Graph or sub-graph, CGRUs 503-504 may use PMUs 509, 510, and 511 as a logical buffer 540 to temporarily store data that is destined for CGRUs 538 and/or 539.

As will be seen further hereinafter, PMUs 509, 510, and 511 include memory that may be used as memory storage areas or memory store (MS) circuits or MS 513, 517, and 523, respectively. PMUs 509-511 also include respective control logic (CL) circuits or CL 515, 519, and 525 that may be used for, among other things, address calculation and control for respective MS circuits 513, 517, and 523. An implementation may include that control logic (CL) circuits 515, 519, and 525 may be configured to calculate any number and combination of concurrently generated read addresses and write addresses to or from MS 513, 517, and 523.

PMUs 509-511 also include respective configuration store/logic circuits or configuration store (Cfg.) circuits or Cfg 516, 520, and 526 that may be implementations of and function substantially the same as Cfg 402 described in the description of FIG. 4. Cfg 516, 520, and 526 may store unit files of configuration data that is particular to the respective PMU. Cfg 516, 520, and 526 may each include a set of storage location(s) and/or control logic, such as for example registers or flip-flops, that store status usable to facilitate operation of the PMU and respective control logic circuits, or to track progress for execution of a Graph or sub-graph. Cfg 516, 520, and 526 may be configured to have a configuration file having control or status information as described in the description of Cfg circuit 402 wherein the configuration file represents the initial configuration, or starting state, or parameters for the operation of one or more of the components of the PMU. The configuration file data for Cfg 516, 520, and 526 may be loaded therein by a unit configuration load process, such as for example, receiving and loading data particular to the PMU from one or more of the data busses of interconnects 422.

PMUs 509, 510, and 511 also include respective semaphore control (SCC) circuits or SCC circuits or SCCs 514, 518, and 524. As will be seen further hereinafter, SCC circuits (SCCs) 514, 518, and 524 within the corresponding PMUs are configured to assist in sequencing the reading of data from PMUs 509-511 by the destination CGRU such as for example CGRUs 538-539. Semaphore control circuits, such as for example any one or more of SCCs 514, 518, or 524, are not restricted to being within a PMU but may be disposed in any CGRU or other configurable unit.

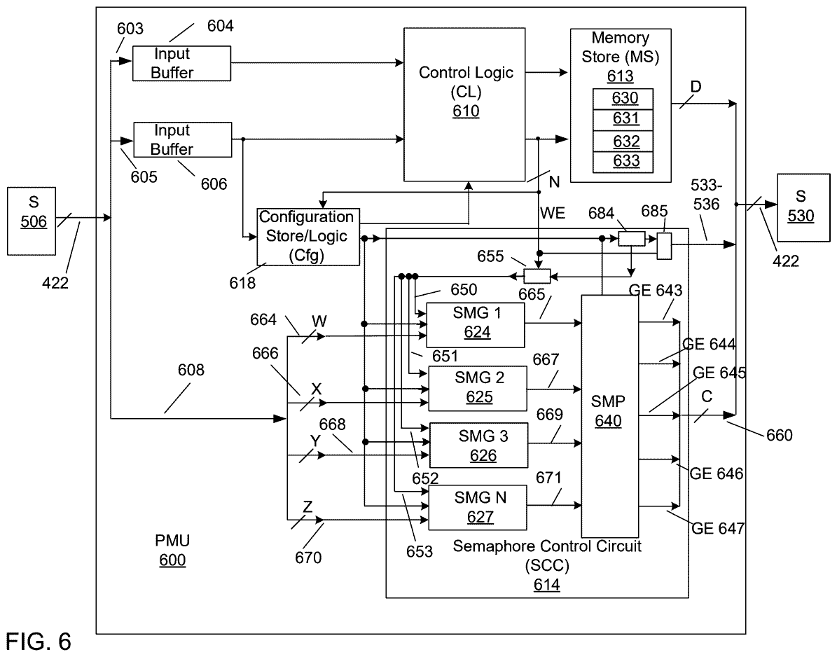

FIG. 6 illustrates a simplified block diagram of an example of an implementation of a PMU 600. Any one or more of PMUs 509-511 (FIG. 5) or any PMU in CGR array 400 (FIG. 4) may have an implementation that may be substantially the same as or may operate substantially the same as PMU 600. PMU 600 includes an example of an implementation of a semaphore control (SCC) circuit or SCC 614 that may be an implementation of any one or more of SCCs 514, 518, or 524 of respective PMUs 509, 510, and 511 (FIG. 5) or any PMU in CGR array 400 (FIG. 4).

Input buffers 604 and 606 of PMU 600 are connected to respective data bus 603 and 605 of interconnect 422. One of buffers 604 or 606 may be connected to a vector bus of interconnect 422 to receive vector data from one of buses 603 or 605, and the other one of buffers 604 or 606 may be connected to a scalar bus of interconnect 422 to receive scalar data from the other one of buses 603 or 605. Buffers 604 and 606 may be implemented as FIFO buffers or any other known buffer implementation.

PMU 600 includes a memory storage area or memory store circuit or memory store (MS) or MS 613 that may be an implementation of any one of memory store (MS) 513, 517, or 523 of respective PMUs 509-511 (FIG. 5) or any PMU in CGR array 400 (FIG. 4). Memory store (MS) 613 may be configured as any type of memory of any size including SRAMS, DRAMS, flip flops, etc. An implementation of memory store (MS) 613 may include up to 8K (8192) words of SRAM. Each word may have any number of bits. An implementation may include words having 128 bits per word. An implementation of memory store (MS) 613 may be subdivided into one or more logical sub-buffers or local buffer storage areas or local buffers to store data for one or more different data groups. In an implementation, MS 613 may be subdivided into N local buffers 630-33. FIG. 6 illustrates MS 613 divided into four local buffers so that N would be the number four, but in other implementations MS 613 may not be sub-divided or alternately may be sub-divided into fewer or more local buffers.

As indicated hereinbefore, control logic (CL) circuit or CL 610 may include circuits for address calculation and control of writing and reading MS 613. CL 610 may also include control circuits to control the bus interfaces to buffers 604 and 606, and to control routing the outputs of buffers 604 and 606 to MS 613 or to other internal circuits. Control logic (CL) circuit 610 may be configured to support concurrent generation of multiple addresses to access locations in MS 613. Any number and combination of concurrently generated read addresses and write addresses may be supported, depending on the implementation. One implementation can support simultaneous generation of multiple write addresses and multiple read addresses to memory store (MS) 613. CL 610 may utilize data from buffers 604 and 606 and control information from Cfg 618 for calculation of addresses for reading from or writing to MS 613. CL 610 may also generate one or more write enable (WE) signal(s) to indicate that a data word is written into memory store (MS) 613, such as for example from one of buffers 604 or 606. An implementation may include that the WE signal is a group of N write enable signals. An implementation may include one write enable (WE) control line for each local buffer of MS 613. SCC 614 receives the WE signals to signify that a word was written into MS 613.

Configuration store/logic (Cfg) circuit 618 may be used to store unit files of configuration data that is particular to PMU 600. Cfg 618 may be an implementation of any one of Cfg 516, 520, or 526. Consequently, Cfg 618 may include a set of storage locations or control logic, such as for example registers or flip-flops, that store a configuration file having control or status information representing the initial configuration, or starting state, of one or more of the circuits of PMU 600. For example, Cfg 618 may store information or data that represent either the initialization data for some of the PMU circuits, or the sequence to run a Graph or a portion of a graph. Cfg 618 may also store status information usable to track progress during execution of a Graph or sub-graph. Additionally, Cfg 618 may include instructions to be executed for the PMU, the source of the operands, the number of nested loops, the limits of each loop iterator, and the network parameters for the input and output interfaces, such as for example, but not limited to, configuration and/or initialization data for CL 610 and SCC 614. The data for Cfg 618 may be loaded into Cfg 618 by a unit configuration load process, such as for example, receiving and loading data particular to the configurable unit from one or more of data busses 603 or 605. Referring back to FIG. 5, Cfg 516, 520, and 526 (FIG. 5) may also store information or data that represent the configuration and/or initialization data for respective CL 515, 519, and 525 and for respective SCC 514, 518, and 524.

Referring to FIGS. 5 and 6, during the execution of a Graph or sub-graph, the source CGRUs, such as for example CGRUs 503-504, may use PMUs 509-511 as a logical buffer 540 to store information that may be intended for a destination CGRU such as for example CGRU 538-539. CGRUs 503-504 may send portions of a group of data, or data group portions, to different ones of PMUs 509-511. This operation may be referred to as scattering data of a group of data among the PMUs. As will be seen further hereinafter, during the scattering of the data among the PMUs, the source CGRUs (such as CGRUs 503 and 504) may both be writing data to the PMUs such that the writing from the CGRUs may not be stored sequentially in the PMU memory stores. Thus, the data may be stored in the PMUs out of order from the original order stored in the CGRUs. Also, some of the write operations from the source CGRUs may overlap each other such that data from the source CGRUs may be intermixed in the memory stores of the PMUs. Additionally, one CGRU may finish writing all of one data group before another CGRU is finished, thus the data may be out of sequence. After the source CGRUs have scattered all the data to the PMUs, the destination CGRUs need to retrieve the data. Since the data is scattered among the PMUs, it is desirable that the reading of the data be sequenced such that all of the data of a particular group, for example all data of a particular sequence, be read before data of a different group, or different sequence, is read.

SCC 614, and corresponding, SCCs 514, 518, and 524 (FIG. 5), are configured to facilitate sequencing the gathering of the data from the PMU by the destination CGRU. As will be seen further herein after, SCCs 514, 518, and 524 may be configurable to selectively detect the configurable units completing reception of all data of a first data group and to responsively notify one of a source CGRU or another CGRU, such as for example destination CGRUs 538 and/or 539. For example, send a control signal signifying the reception of all of the data of a particular data group. Semaphore control (SCC) circuit 614, and SCCs 514, 518, and 524, include N number of semaphore generation (SMG) circuits or SMGs 624-627. The number (N) of semaphore generation (SMG) circuits may be selected to represent the number of local buffers that MS 613 can be subdivided or partitioned into, such as for example partitioned as specified by complier 182 (FIG. 1) of host 180 or by run time logic 186. In an implementation, MS 613 may be subdivided into up to four (4) local buffers 630-633, thus SCC614 would have four (4) SMGs 624-627. However, N may be other values in other implementations.

SMGs 624, 625, 626, 627 have respective groups of inputs 664, 666, 668, and 670 that are connected to a control bus 608 of interconnect 422. Inputs 664, 666, 668, and 670 receive control signals from external to PMU 600 via the control bus of interconnect 422. Inputs 664, 666, 668, and 670 have respective W, X, Y, and Z number of inputs that receive the corresponding number of control signals. In an implementation, the number W, X, Y, and Z of inputs may all be different or may all be the same number. Inputs W, X, Y, and Z may have an implementation where W, X, Y, and Z may all be eight separate control signals. For the implementation of N being four and inputs W, X, Y, and Z all being eight, SMGs 624-627 have at least thirty-two (32) control signals that are received from control bus 608 of interconnect 422. SMGs 624, 625, 626, 627 also have respective outputs 665, 667, 669, and 671.

SMGs 624-627 count data that is written into MS 613. During an operation to write data into MS 613, CL 610 receives data from one of buffers 604 or 606. As indicated hereinbefore, control logic (CL) circuit 610 may include circuits for address calculation and control of writing and reading memory store (MS) 613. As indicated hereinbefore, the data to be written may be included within a data packet or packet. The packet may include sequence information or sequence numbers (seq ID) that may, among other things, identify that the data is part of one sequence of data. An implementation may include that the seq ID is in a packet header. The seq ID may identify which of buffers 630-633 the data is to be written into and may also identify which of SMGs 624-627 is to count the data that is written. The sequence number may be used to reassemble the order of the data packets when the packets are received out of order.

The address generation and calculation circuits of CL 610 write data of the same sequence number into one or more of the local buffers 630-633. CL 610 also asserts one of the N number of WE signals corresponding to the write to that buffer. A routing circuit 655 of SCC 614 receives the WE signals from CL 610 and routes the WE signals to SMGs 624, 625, 626, 627 which each receive one of the N number of WE signals and counts each write to the corresponding local buffer of MS 613. In one implementation, SMG 624 receives a first WE signal 650 for writes to buffer 630, SMG 625 receives a second WE signal 651 for writes to buffer 631, SMG 626 receives a third WE signal 652 for writes to buffer 632, and SMG 624 receives a fourth WE signal 653 for writes to buffer 633. SMGs 624-627 count assertion of the respective WE signal to count writes to the corresponding local buffer.

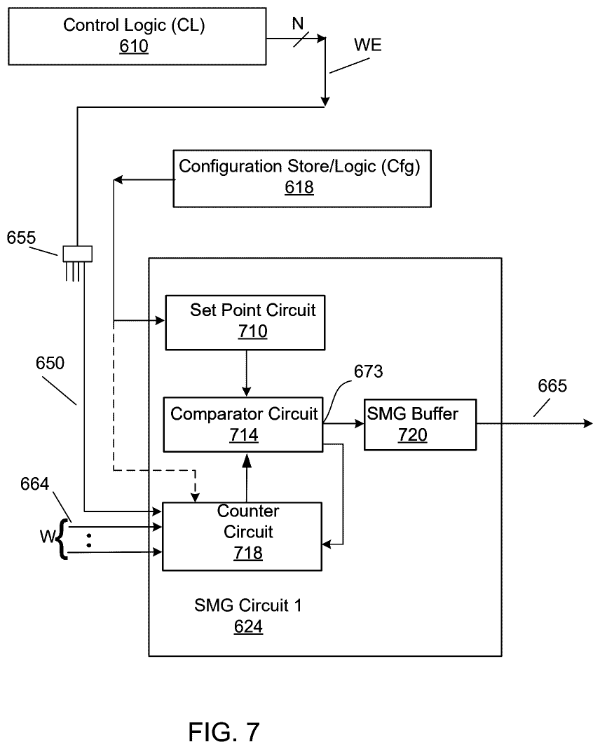

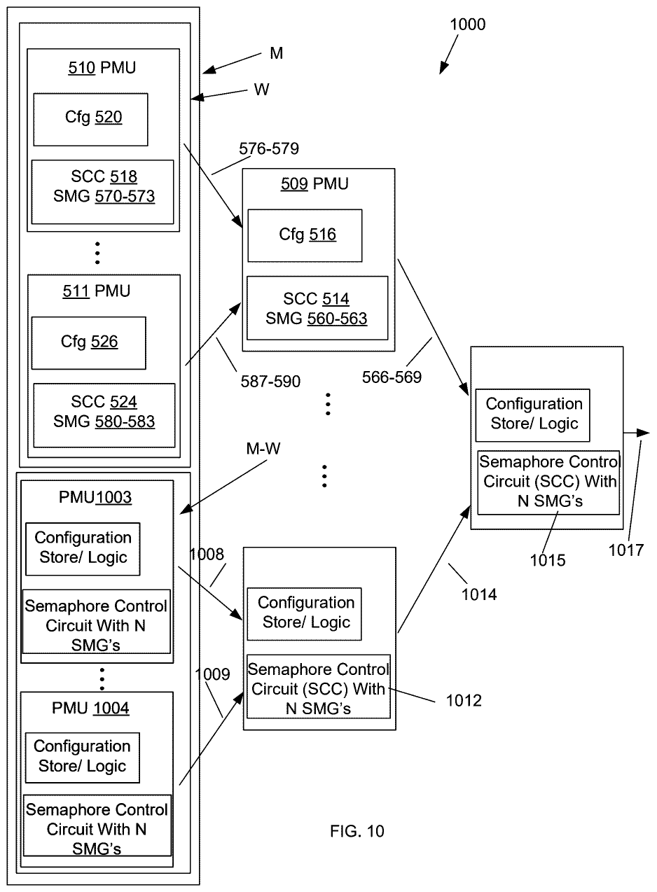

FIG. 7 illustrates a simplified block diagram of an example of an implementation of SMG 624 (FIG. 6) that may be an implementation of any one or more of SMGs 625-627 or alternately any SMG of any of SCCs 514, 518, or 524 (FIG. 5). SMG 624 includes a counter circuit or counter 718, a comparator circuit 714, a set point circuit 710, and an SMG buffer circuit or buffer 720. Counter 718 may be an up/down counter or other type of counter. Counter 718 has a sufficient number of bits to count a value equal to the total capacity of MS 613 plus bits to count assertions of each of the W number of inputs. For the case of MS 613 having a capacity of 8192 words and W representing eight inputs, counter 718 may have eighteen bits or alternately 19 bits. Counter 718 receives first WE signal 650 from routing circuit 655. An implementation of counter 718 increments the count for each asserted state of first WE signal 650. SMG 624 also includes a set point circuit 710. Set Point circuit 710 is loaded by Cfg 618 with a target value for counter 718. An implementation may include that the target value may represent a total amount of data that will be received in a particular data group. A comparator circuit 714 compares the value in counter 718 to the target value in circuit 710 and asserts an output signal on output 673 in response to the two being the same value. Buffer 720 is configured to save the status of SMG 624 or alternately the asserted state of output 673. For example, once counter 718 reaches the target value, it may be restarted for another cycle with another target value. Buffer 720 saves the status while SMG 624 begins working on the next cycle. Buffer 720 may include multiple storage locations in order to store multiple states, for example multiple sequential states of SMG 624. An implementation may include that buffer 720 may be a multi-deep FIFO. SMG 624 may have other implementations in other SMG implementations. For example, counter 718 may be loaded with the target value, for example as illustrated by the dashed line into counter 718, and first WE signal 650 may decrement counter 718 until it reaches zero, or other implementations. Another implementation of SMG 624 may include that counter 718 may be selectively configured to count up, including counting changes in inputs 664, and to subtract the target value from the value of counter 718. For example, subtract the value in circuit 710 from the value of counter 718. This operation may be useful in the semaphore hierarchy configuration described in the explanation of FIG. 10.

SMG 624 also has W number of inputs that receive input signals from control bus 608. As will be seen further hereinafter, SMG 624 is also configured to selectively count an assertion of any one of the W input signals as a part of the count in counter 718. SMGs 625-627 (FIG. 6) have respective X, Y, and Z number of inputs that also receive input signals from control bus 608.

Referring back to FIG. 6, semaphore control (SCC) circuit 614 also includes a semaphore priority control (SMP) circuit or SMP 640 that assists in generating gather enable (GE) signals in an order that facilitates sequencing the reading of data from PMU 600. SMP 640 receives output signals from outputs 665, 667, 669, and 671 of respective SMGs 624, 625, 626, 627. Each signal on outputs 665, 667, 669, and 671 may have an implementation of a single signal having an asserted state indicating that all the data for a particular data group has been received by the PMU or group of PMUs (509-511 FIG. 5). SMP 640 has gather enable (GE) signals or GE signals or GE 643, GE 644, 645, 646, and 647 that are connected as outputs to a control bus 660 of PMU 600. Control bus 660 is connected to the control bus of interconnect 422. One or more of Gather enable (GE) signals or GE 643-647 are sent to a destination unit such as CGRU 538 and 539 (FIG. 5) indicating that a particular set of data is ready to be read or gathered by the destination unit. Any one or more of signals GE 643-647 may also be sent to a source CGRU to inform the source CGRU that all of a data group has been received and so that the source CGRU may begin sending data of another data set to a destination. Notifying a source CGRU that the data sent by the source has been received allows the source to sequence sending a second set of data after all of the first data has been received. This assists in synchronizing CGRU activities within the Array. For example, this sequence may be used in executing a Single Buffer write operation. An implementation may include that each individual signal GE 643-647 is coupled to a corresponding individual control input of a source CGRU or a destination CGRU through being coupled to a corresponding individual control line of control bus 660. Thus, each source or destination CGRU may identify the configurable unit that sent the control signal. Signal 643 generates a stream of GE signals so that the receiver of the GE signals does not have to combine the individual GE 644-644 signals. In other implementations, the status of signals GE 643-647 may be sent by means of a control word or status word instead of a control line.

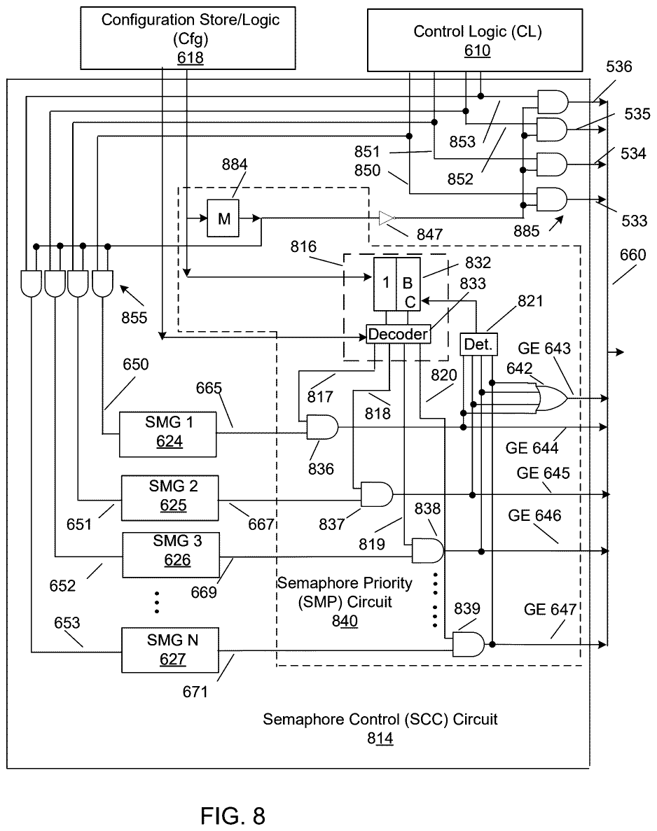

FIG. 8 illustrates a simplified block diagram of an example of an implementation of a semaphore control (SCC) circuit 814 having a semaphore priority control (SMP) circuit or SMP 840, illustrated in a general manner by a dashed box, that may be an implementation of respective semaphore control (SCC) circuit 614 and SMP circuit 640 (FIG. 6). SCC 614 and SMP 640 may have a different implementation from SMP 840 as long as the implementation facilitates sequencing the reading of the PMU data by the destination CGRU.

SMP 840 includes a mode (M) control circuit 884 that facilitates, as will be seen further hereinafter, SCC circuit 814 selectively operating in a master control mode or secondary mode. Mode control circuit 684 (FIG. 6) may have an implementation that may be substantially the same as circuit 884 or circuit 884 plus circuit 847, or alternately may be implemented differently but may have similar operational functionality. Routing control circuits 855 and 885 also assist in the master or secondary operational modes. Routing control circuits 655 and 685 (FIG. 6) may have implementations that may be substantially the same as respective circuits 855 and 885, or alternately may be implemented differently but may have similar operational functionality. An asserted state of circuit 884 selectively configures SCC circuit 814 to operate in the master control mode, conversely, the negated state of circuit 884 selectively configures SCC circuit 814 to operate in the secondary mode. The asserted state of circuit 884 enables routing control circuit 855 to route write enable signals 850-853 from CL 610 to corresponding WE signals 650-653 and prevents asserting reception signals 533-536 from routing control circuit 885. A negated state of circuit 884 enables routing control circuit 885 to route write enable signals 850-853 from CL 610 to corresponding reception signals 533-536. The negated state of circuit 884 also inhibits asserting any of WE signals 650-653 which inhibits SMGs 624-627 from counting the writing of data to the PMU. However, SMGs 624-627 can still receive and count assertion of respective signals received on inputs 664, 666, 668, and 670 (FIG. 6).

An implementation of SMP 840 may include AND gates 836-830 and an OR gate 842. OR gate 842 has a GE output 643. SMP 840 includes a pointer circuit or pointer 816, illustrated in a general manner by a dashed box. Pointer circuit 816 includes at least N number of outputs having output signals 817-820 where the number N of outputs is the same number as the N number of SMGs 624-627. An implementation of pointer circuit 816 may include a counter circuit or counter 832 and a decoder circuit or decoder 833. Counter 832 has a number B of bits that facilitates counter 832 counting to at least the number N of SMGs 624-627. Decoder 833 decodes the output of counter 832 and individual ones of signals 817-820 are asserted in response to decoding the number in counter 832. For example, for counter 832 having a count of zero, signal 817 is asserted. A detector circuit or detector 821 detects a change to an asserted state of one of GE 644-647 and provides a pulse output to a clock input of counter 832 in order to increment counter 832. However, the pointer circuit and associated decoder and clocking of the pointer circuit, for example detector 821, may have various other implementations as long the implementation facilitates sequencing the reading of the PMU data by the destination CGRU. Pointer circuit 816 may be initialized by a control signal from Cfg 618. An implementation may initialize pointer 816 to an initial condition of all zeros.

As decoder 833 decodes the state of counter 832, an asserted state of signal 817 enables AND gate 836 to allow the state of output 665 of SMG 624 through gate 836 and force GE 644 to be the same as output 665. Once output 665 of SMG 624 is asserted, GE 644 is also asserted. OR gate 842 receives the asserted state of output 644 and responsively asserts GE 643. Detector 821 detects the transition to an asserted state of GE 644 and provides a pulse to the clock input of counter 832 in order to increment counter 832, for example to a count of one. Decoder 833 decodes the output of counter 832 and asserts output signal 818. The asserted state of signal 818 enables AND gate 837 to allow the state of output 667 of SMG 625 through gate 837 and force GE 645 to be the same as output 667. If output 667 was already asserted, that assert state is not transferred to GE 645 until after output 665 is asserted. Once output 667 of SMG 625 is asserted, GE 645 is also asserted. OR gate 842 receives the asserted state of output 645 and responsively asserts GE 643. Detector 821 detects the assertion of GE signal 645 and again provides a pulse to the clock input of counter 832 to again increment counter 832, for example to a count two. Decoder 833 decodes the count of counter 832 and asserts signal 819 which enables gate 838 to transfer the state of output 669 to GE 646. If output 669 was already asserted before output 667 was asserted, the negated state of output 667 would prevent, via gate 838, the state of output 669 from asserting GE 646. Thus, the asserted state of an SMG circuit is not transferred to the corresponding SMP output until the previous SMG output is asserted. Once output 669 is asserted, gate 838 transfers the asserted state to GE 646. OR gate 842 receives the asserted state of output 646 and responsively asserts GE 643. Detector 821 again detects the transition to the asserted state and causes counter 832 to increment, for example to a count of three. Decoder 833 decodes the output of counter 832 and asserts output signal 820 which enables gate 839 to transfer output 671 to GE 647. If output 671 was already asserted before decoder output signal 820 was asserted, the negated state of signal 820 prevents, via gate 839, the state of output 671 from asserting GE 647. Once output 671 becomes asserted, the asserted state is transferred to GE 647. OR gate 842 receives the asserted state of output 647 and responsively asserts GE 643. Detector 821 again detects the asserted transition and provides a clock to counter 832 to increment the counter back to zero. The count of zero allows the cycle to start over. Thus, SCC circuit 814 rotates the priority of providing the gather enable (GE) signals to the destination CGRU. SCC circuit 814 sequences providing gather enable (GE) signals to the destination CGRU so that the destination CGRU reads the data from PMU 600 in order, such as for example an original order of the data or alternately an order provided in the sequence number of each data group.

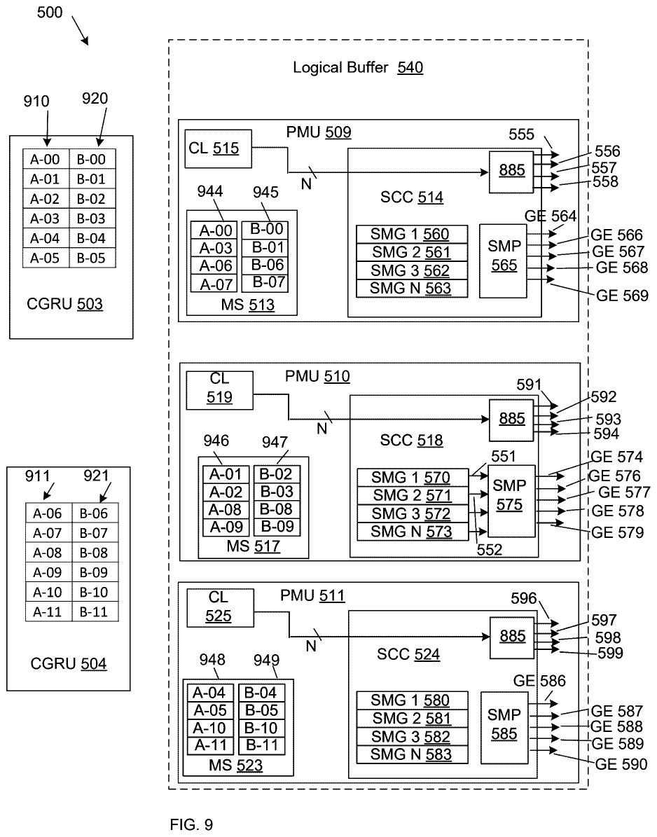

FIG. 9 graphically illustrates a simplified block diagram of a portion of an example operation of source CGRU 503-504 sending one or more groups of data, or data groups, to destination CGRU 538-539. Each data group may include a plurality of data packets that may be transferred by a transaction, such as for example a transaction of a data flow operation. Although FIG. 9 illustrates two (2) source CGRUs sending data to two (2) destination CGRUs through three (3) PMUs, any number of source CGRUs may be sending data to any number of destination CGRUs. The transaction may use any number of PMUs or may use some other intermediate unit instead of PMUs.

PMUs 509-511 (FIG. 5) include respective SCC circuits or SCC 514, 518, and 524. SCC 514 of PMU 509 includes an SMP circuit or SMP 565 and N number of SMG circuits or SMGs 560-563. GE signals or GE 564 and 566-569 of SMP 565 may have an implementation that functions similarly to respective GE 643 and 645-647 of SMP 640 (FIG. 6). SCC circuit or SCC 518 of PMU 510 includes an SMP circuit or SMP 575 and N number of SMG circuits or SMGs 570-573. GE signals or GE 574 and 576-579 of SMP 575 may have an implementation that functions similarly to respective GE 643 and 645-647 of SMP 640 (FIG. 6). SCC circuit or SCC 524 of PMU 511 includes an SMP circuit or SMP 585 and N number of SMG circuits or SMGs 580-583. GE signals or GE 586 and 587-590 of SMP 585 may have an implementation that functions similarly to respective GE 643 and 645-647 of SMP 640 (FIG. 6). SMPs 565, 575, and 585 may have an implementation that is configured to function substantially the same as SMP 640 (FIG. 6) or 840 (FIG. 8) although may have different circuit implementations than SMP 640 or 840. Any one of SMG 560-563, 570-573, or 580-583 may have an implementation that functions similarly to or alternately configured substantially similarly to respective SMG 624-627 of FIGS. 6-8 although may have different circuit implementations. SMGs 560-563, 570-573, and 580-583 all have outputs that function substantially the same as outputs 665-671 of respective SMGs 624-627 (FIG. 6), but may have implementations with different circuit elements. For example, SMGs 570 and 571 have respective outputs 551 and 552 that correspond to respective outputs 665 and 667. Cfgs 516, 520, and 526 (FIG. 5) of respective PMU 509-511 are configured to provide the same functional operation as Cfg 618 but may have implementations with different circuit elements.

For this example, assume that CGR array 500 (FIG. 5) will send data from CGRU 503-504 to CGRU 538-539. A first flow of transactions may configure CGRU 503-504 with a first data group having data 910-911 that may be distributed among PMU 509-511. A second flow of transactions may configure CGRU 503-504 with a second data group having data 920-921 that may be distributed among PMU 509-511. The first data group includes data 910 in CGRU 503 that has data elements A-00 through A-05 and also includes data 911 in CGRU 504 that has data elements A-06 through A-11. The second data group includes data 920 in CGRU 503 that has data elements B-00 through B-07 and also includes data 921 in CGRU 503 that has data elements B-06 through B-11. Each data element in the first data group, data 910-911, and second data group, data 920-92,1 may be any one of vector data, scalar data, or other data having packets that include headers.

As will be seen further hereinafter, the source CGRUs may send portions of a data group of a data flow to different ones of PUMs 509, 510, and 511. As indicated hereinbefore, this operation may be referred to as scattering the data of the data group, or data of the flow, among the PMUs such that the data may be stored out of sequence in the PMUs. Semaphore control (SCC) circuits of SCCs 514, 518, and 524 are configured to sequence the reading of the data from PMU 509-511 so that the data is read in an order that preserves the order of the flow regardless of the order that the data is stored into the PMU. As indicated hereinbefore, the headers of the packets may include a seq ID that identifies, among other things, which buffer that data is to be written into and which semaphore generation circuit counts that data that is written. In other implementations, the buffer and the semaphore generator circuit may be identified by other identification means.

For the data transfer operation, configuration store (Cfg) 516, 520, and 526 (FIG. 5) may be initialized with a configuration file to include initialization conditions and control parameters for operation of CL 515, 519, and 525, along with SCC 514, 518, and 524. In this example, the parameters in Cfg 516, 520, and 526 may control the formation of N number of local buffers within MS 513, 517, and 523, that may be at least the same as the number of data groups that the source CGRU will send to the PMU. For example, the configuration file may initialize respective Cfg 516, 520, and 526 so that control circuit CL 515, 519, and 525 are configured to control address generation circuits for respective MS 513, 517, and 523 to form the respective local buffers. In this example, PMU 509 forms local buffers 944-945, PMU 510 forms local buffers 946-947, and PMU 511 forms local buffers 948-949. The configuration file may also include the total amount of data that will be transferred in a data group, for example the total amount of data in the first data group, data 910 plus 911, and another total for the total amount of data in the second data group, data 920 plus 921. The configuration file also initializes Cfg 516, 520, and 526 to control the operation of PMU 509-511 and corresponding SCC 514, 518, and 524, so that one PMU operates as a master PMU and corresponding master SCC, and the other PMUs operate as secondary PMUs and corresponding secondary SCCs. For example, the configuration file may include configuring control information that asserts the mode control circuit, for example circuit 684 or 884 (FIGS. 6 and 8), of the SMP circuit corresponding to the master PMU, and to negate the information in the mode control circuit, for example circuit 684 or 884 (FIGS. 6 and 8), of the SMP circuits corresponding to the secondary PMUs. The master PMU and master SCC accumulate a count of all the data from the data group that is written to all of the PMUs and controls the sequence that data will be read out of the PMUs. In an implementation, the master SCC counts write signals (WE signals 650-653 FIGS. 6 and 8) generated by the respective control logic (CL 515, 519, or 525) of the master PMU. Counting assertions of the write signals facilitates counting the data transfers into the master PMU. The write signals may be generated to store the data into the memory store of the master PMU. The secondary SCC does not count writes of data to the secondary PMU. Instead, the secondary SCC sends a reception signal to the primary PMU where the reception signal is generated responsively to the secondary PMU writing data into the memory store. For example, referring to FIGS. 6 and 8, the negated state of mode control circuit 684 or 884 and the blocking of WE signals 850-853 by routing circuit 655 or 855, prevents signals 650-653 from being asserted and prevents the SMG circuits from counting writes to the PMU. However, the negated state of mode control circuit 684 or 884 enables routing circuit 685 or 885 to send write signals 850-853 to reception signals 533-536 in response to the write signals within the secondary PMU. The primary SCC receives the reception signal(s) from the secondary PMU and counts the reception signals as included in the count within the SMGs of the primary SCC. The primary SCC accumulates the total of the reception signals received from the secondary PMUs as a part of the total write operations to the PMUs. Thus, the master SCC counts all the writes to all of the PMUs.

For an example, assume that Cfg 516, 520, and 526 initialize SCC 518 of PMU 510 to be master SCC and configures SCCs 514 and 524 to be secondary SCCs. Cfg 520 configures SMG 570 to count data written into buffer 946, and configures SMG circuit 571 to count data written into buffer 947. Secondary SCC 514 is configured to send a reception signal 555 to SMG 570 and another reception signal 556 to SMG circuit 571 in response to a write of data into respective buffers 944 and 945. Similarly, secondary SCC 524 is configured to send a reception signal 596 to SMG circuit 570 and another reception signal 597 to SMG circuit 571 in response to a write of data into respective buffers 948 and 949. Thus SMG 570 receives a first reception signal, for example signal 555, from SCC 514 and a second reception signal, for example signal 596, from SCC 524. SMG 570 counts the reception signals along with the writes to 946 to form the total amount of the first data group that is written to PMUs 509-511. Similarly, SMG 571 receives a third reception signal, for example signal 556, from SCC 514 and a fourth reception signal, for example signal 597, from SCC 524. SMG 571 counts the received signals along with the writes to 947 to form the total amount of the second data group that is written to PMUs 509-511. Thus, SCC circuit 518 counts all of the writes to the corresponding buffers of each PMU 509-511. For this example of two local buffers, SCCs 514 and 524 send respective reception signals 555-556 and 596-597 to SMG 570-571 via the control bus, such as bus 660 or 608 (FIG. 6).

As indicated hereinbefore, the configuration file may include the total amount of data that will be transferred in the first data group and the second data group. In this example, the configuration file stored in Cfg 520 includes a first total data count for the first data group, data 910-911, and a second total data count for the second data group, data 920-921. Cfg 520 stores the total data count for data 910-911 into set point circuit 710 (FIG. 7) of SMP 570 and stores the total data count for data 920-921 into set point circuit 710 (FIG. 7) of SMP 571.

During execution of the transactions, CGRU 503 and 504 are configured to write data from the respective first data group before witting data from the respective second data group. For example, CGRU 503 is configured to write all the data of the first data group, data 910, before writing data from the second data group, data 920, similarly, CGRU 504 is configured to write all the data of the first data group, data 911, before writing data from the second data group, data 921. As will be seen further hereinafter, the semaphore control (SCC) circuits are configured to prevent reading of the second data group until after the first data group is all stored in the PMUs.

For this example of FIG. 9, assume that CGRU 503 begins to write data from data 910 and CGRU 504 begins to write data from data 911 into PMU 509-511. Assume that CGRU 503 writes data A-00 into buffer 944. The data packet for data A-00 includes the seq ID which identifies which sub-buffer that data is to be written into and which SMG circuit counts the data. SCC 514 responsively asserts reception signal 555 which is received via the control bus by SMG 570 which counts the reception signal as a write of the first data group. CGRU 503 then writes data A-01 to buffer 946 of MS 517. The data packet for data A-01 includes the seq ID which identifies which sub-buffer that data is to be written into and which SMG circuit counts the data. SCC 518 asserts WE signal 650 (FIG. 6 or 8) and SMG 570 responsively counts data A-01 written to MS 517.

Assume that CGRU 504 writes data A-03 to buffer 944. SCC 514 responsively asserts reception signal 555 indicating a write to buffer 944 of the first data group. Reception signal 555 is received via the control bus by SMG 570 which counts the reception signal as a data write of the first data group. The counting of the writes of the first data group (data 910-911) continues and SMG 570 continues to count the data write operations.

Assume that CGRU 504 completes writing all of the first data group data 911, and begins to write data from the second data group, data 921, while CGRU 503 is still writing data from the first data group. Further assume that CGRU 504 has completed writing all of the data of the second data group, data 921. Because all of the data of the first data group, data 910 in this portion of the example, has not yet been written to the PMUs, output 551 of SMG 570 is not asserted. Thus, as explained hereinbefore in the description of FIGS. 6 and 8, SMP 575, corresponding to SMP 840 (FIG. 8), of SCC 518 would keep GE 574 and 577 negated until after all of the first data group were written to the PMUs and SMG 570 reaches the corresponding target value. Therefore, even if all of the second data group data were written to the PMUs, GE 574 and 577 remain negated. After SMP 575 asserts GE 576, SMP 575 is enabled to assert GE 577 in response to SMG 571 reaching the second target. For example, the SMP 575 pointer that corresponds to pointer 816 (FIG. 8) increments and responsively allows assertion of GE 577 and GE 574.

Although in this example implementation PMU 509-511 are illustrated as using two buffers corresponding to the two data groups in CGRU 503-504, any of the PCU's or PMUs may have N number of buffers as described herein before.

In another example, one or more of source CGRUs 503-504 may execute a graph wherein only one buffer is used in any one or more of a destination CGRU including a PMU such as for example one or more of PMUs 509-511. This may be referred to as a Single Buffer sequence, for example as explained hereinbefore in the description of FIG. 6. The source CGRU may write the data of a first data set to the destination CGRU. Once the destination CGRU has received all of the first data set, the SCC circuit may assert one of the GE signals to identify receiving all of the first data set. Once the source CGRU receives the GE signal, the source CGRU may responsively begin writing a second data set to the destination. This notification sent to the source CGRU can assist in synchronizing operations within an array and may also assist in allowing the source CGRU to suspend sending data to the PMU while performing other operations.

FIG. 10 illustrates a simplified block diagram of a CGR array 1000 that may be an implementation of at least a portion of CGR array 400 or 500 (FIG. 4 or 5). CGR array 1000 includes a plurality of PMUs and SCC circuits configured in a semaphore hierarchy configuration or hierarchy that allows sequencing the reading of data from more PMUs than an SMG has inputs. In an implementation, the hierarchy may have three tiers. The first tier includes a group of M number of PMUs. The second tier is a group of SCC circuits which may or may not be part of a PMU or other configurable unit. This example of a second tier includes PMU 509 and an SCC circuit 1012. However, the second tier may have an implementation that includes other number of SCC circuits, as illustrated by the dotted extension marks extending between PMU 509 and SCC circuit 1012. The third tier is another SCC circuit 1015. SCC circuits 1012 and 1015 may be substantially the same as any of SCCs 514, 518, 524 of FIG. 5, or SCC 614 (FIG. 6), or 814 (FIG. 8). SCC circuits 1012 and 1015 may or may not be a part of any type of CGRU. PMUs 1003-1004 and SCC circuits 1012 and 1015 have respective GE output signals 1008, 1009, 1014, and 1017 that are plurality of output signals that are configured to operate in a manner similar to at least any of GE 644-647 (FIG. 8) or GE 566-569 or 576-579 or 587-590 (FIG. 9). Another implementation of a hierarchy may include more or fewer than three tiers.

If a system has more PMUs that receive data than the SMGs of an SCC circuit has inputs to receive (for example more PMUs than the W number of inputs for SMG 624 of FIG. 6 or 8), then that one SCC circuit cannot count the writes of all of the PMUs. For example, an implementation of an SMG may have eight inputs to receive control signals from eight other PMUs. Thus, the SMG can only count data that is written to eight other PMUs (other than the PMU that contains the SMG). Coupling the SMG circuits in the hierarchy facilitates counting data that is written to more PMUs than the SMG has inputs to receive., or alternately counting data written to more PMUs than the W or X or Y or Z number of SMG inputs, for example the inputs of SMG 624 (FIG. 6 or 8). CGR array 1000 includes M number of PMUs (where M is greater than W) coupled in the hierarchy structure or hierarchy. In this example, the number M of PMUs is greater than the number W of inputs of the SMG circuits. Thus, the M number of PMUs is divided into a group of W PMUs and another group of M−W (M minus W) PMUs. All of the M number of PMUs are configured to operate in the secondary mode and the priority circuits therein are disabled. Thus, all of the M number of PMUs each send the corresponding gather enable (GE) signals, over the control bus of the ALN, to the inputs of another SCC circuit. The W number of PMUs send the gather enable (GE) signals to the SMG circuits of PMU 509. The M−W number of PMUs send the gather enable (GE) signals to the SMG circuits of SCC circuit 1012. The SCC circuits of the W number of PMUs each have N number of gather enable (GE) output signals that correspond to GE 576-579 and GE 587-590 (FIG. 9), and the SCC circuits of the M−W number of PMUs each have N number of GE signal outputs that are represented in a general manner by GE signals 1008-1009 which are similar to GE 576-579 (FIG. 9). One of the GE signals from each M number of PMU goes to an input of the corresponding SMG of an SCC circuit. GE signals 576-579 of PMU 510 each go to a different one of SMGs 560-563 of PMU 509. Outputs of the W PMUs (for example eight PMUs) that correspond to GE 576 (FIG. 9) go to the W inputs of SMG 560, thus, SMG 560 receives one signal from each one of the W PMUs. Similarly, outputs of the W PMUs that correspond to GE 577 all go to the W inputs of SMG 561, outputs of the W PMUs that correspond to GE 578 all go to the W number of inputs of SMG 562, and outputs of the W PMUs that correspond to GE 579 all go to the W inputs of SMG 563. Since each SMG has W number of inputs, each SMG can receive one signal from each of the W number of PMUs. Thus, each SMG of PMU 509 counts one output signal from each one of the W number of PMUs. For example, SMG 560 (FIG. 9) receives W number of GE signals 576, one from each of the W number of PMUs. SMG 561 receives W number of GE signals 577, one from each of the W number of PMUs, and SMG 562 receives W number of GE signals 578, one from each of the W number of PMUs, and SMG 563 receives W number of GE signals 579, one from each of the W number of PMUs. Similarly, SCC circuit 1012 has N number of SMG circuits that each have W number of inputs, thus each SMG circuit of SCC circuit 1012 receives one GE signal from each of the M−W number of PMUs.

All of the M PMUs receive data that is written to the PMU's memory store. The SMG circuits of the M PMUs count the data as it is written into the memory. However, the target value in each of the SMG circuits of the M PMUs are all set to a value of one. Thus, as soon as data is written to the memory of the PMU, the SMG output that corresponds to the local buffer that receives the data is asserted. Additionally, the priority circuit, for example 840 (FIG. 8), of all the SCC circuits of the M PMUs is disabled. For example, an implementation may include that Cfg 618 may be configured to force an asserted state for signals 817-820 (FIG. 8) of decoder 833. Thus, each SMG output assertion immediately asserts the corresponding GE signal. Consequently, a write of data to any of the M PMUs is immediately sent via the corresponding GE signal to the corresponding second tier SCC circuit, the corresponding one of PMU 509 or SCC circuit 1012.

Both SCC circuit 514 of PMU 509 and SCC circuit 1012 are configured to count the GE signals received from the respective W or M−W PMUs. Both of SCCs 514 and 1012 are configured to also have a target value of one and to disable the priority circuit similarly to the M PMUs. However, SCCs 514 and 1012 do not count writes to the corresponding memory stores of PMU 509 or any CGRU that may include SCC1012. Additionally, as explained hereinbefore in the description of FIG. 7, SMGs 560-563 of SCC 514 and the SMG circuits of SCC 1012 are configured to subtract the target value from the value of the counter (corresponding to counter 718) once the counter counts a received signal. Because each SMG of SCCs 514 and 1012 may receive signals on all of the SMG inputs, for example all of the W or X or Y or Z number of inputs, the SMG may receive and count several inputs. Because the target value is set to one, the SMG counter is configured to subtract the target value from the counter value. Subtracting one may leave a value in the counter which then sends another GE signal and the target value is again subtracted from the counter value. This continues until the counter value is again less than the target value. This allows the counter to count several input signals and send a corresponding GE signal for each received input signal. Thus, SCC 514 has N number of GE output signals or GE 566-569 (FIG. 9) that go to the N number of SMG circuits of SCC circuit 1015. Similarly, SCC circuit 1012 has N number of GE output signals illustrated in general as 1014, similar to 566-569, that go to the same N number of SMGs of SCC circuit 1015. Thus, each SMG of SCC circuit 1015 receives one GE signal from PMU 509 and one GE signal from SCC circuit 1012. The set point circuits of the SMG circuits of SCC 1015 are configured with a target value for the total amount of data that is to be counted in a data group to be received by the M number of PMUs. Additionally, the SMP circuit of SCC 1015 is configured to operate as a master PMU so that the GE signals 1017 of SCC circuit 1015 sequence the reading of data from the M PMUs so that the data is read in the sequence or order of the data groups as explained hereinbefore, such as the operation as explained in the description of FIG. 9. SCC circuit 1015 has N number of GE output signals, illustrated in a general manner as GE signal 1017, that are sent to the destination CGRUs 538-539 via the ALN.

Thus, in the hierarchy configuration or hierarchy, a first tier of SCC circuits are configured to send one or more signals corresponding to writes to local buffers of the PMU, the signal is sent to another SCC circuit in a second tier of the hierarchy. The second tier SCC circuits are configured to receive the signals from the first tier SCCs, and responsively send second tier signals to a third tier SCC where the second tier signals are representative of writes to a group of the first tier PMUs. A third tier SCC circuit is configured to receive count the second tier signals that are received by the third tier SCC.

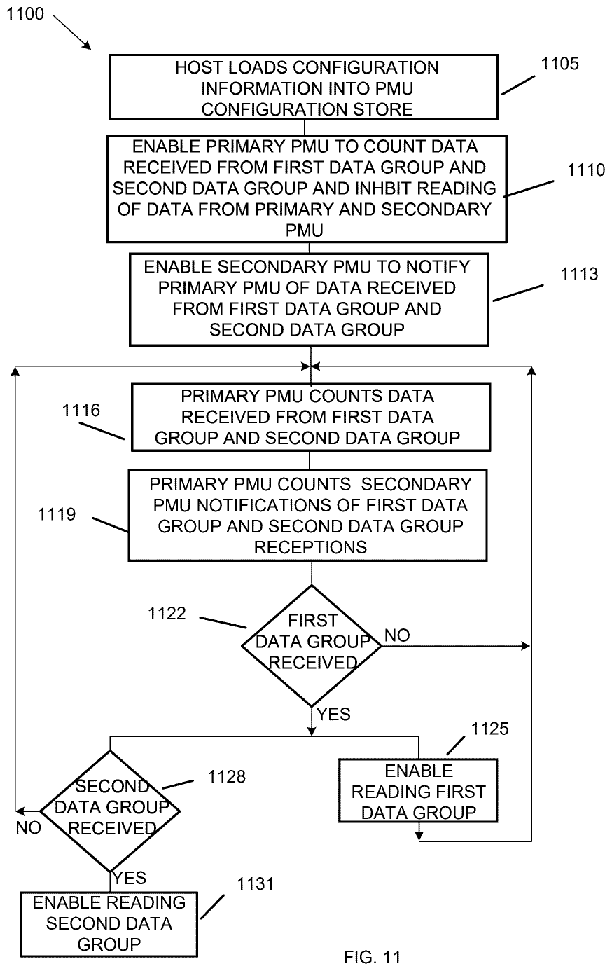

FIG. 11 is a flowchart 1100 illustrating in a general manner some steps in an operation to sequence reading of data from a memory of a PMU in a CGR array. Flowchart 1100 illustrates at 1105 that a configuration store, such as for example Cfg 516 (FIG. 5), may be initialized with a configuration file to include initialization conditions and control parameters for operation of a PMU or group of PMUs. At 1110 of the flowchart, the information in the configuration store may control operation of the PMUs to receive data from one or more data groups, and to control the PMUs to operate in one of a primary mode or a secondary mode. The primary PMU is configured count data that is received, and the configuration information may also inhibit reading of the PMUs. At 1113, the configuration information may also configure the secondary PMUs to not count data that is received, but to send a reception signal to the primary PMU so that the primary PMU can count the reception signals. At 1116, the primary and secondary PMUs receive data. The primary PMU counts data that the primary PMU receives. At 1119, the primary PMU also counts the reception signals received from the secondary PMUs. At 1122 if the primary PMU has not received all of the data from the first data group, the primary and secondary PMUs continue receiving data. However, if the primary PMU detects that all of the first data group is received, the primary PMU at 1125 asserts a first gather enable (GE) signal to signify to the destination CGRUs that the first data group may be read from the PMUs. At 1128 of the flowchart if the primary PMU detects that all of the second data group is not received, the primary and secondary PMUs continue to receive data. However, if the primary PMU detects that all of the second data group is also received, the primary PMU at 1131 asserts a second gather enable (GE) signal to signify to the destination CGRUs that the second data group may be read from the PMUs.

### PARTICULAR IMPLEMENTATIONS

From all the foregoing, those skilled in the art will appreciate that an implementation of a coarse-grained reconfigurable (CGR) processor (CGRP) may comprise:
an array of CGR units (CGRUs) including a first source CGRU, such as CGRU 503, a first Pattern Memory Unit (PMU), such as for example PMU 510, a second Pattern Memory Unit (PMU), such as for example PMU 509, and a first destination CGRU, such as for example CGRU 536, wherein the array of CGRUs is configured to communicate over an array level network, such as for example network 422;
the first source CGRU configured to distribute a first data group, such as for example group 910, among both the first PMU and the second PMU;
the first source CGRU configured to distribute a second data group, such as for example group 920, among the first PMU and to the second PMU;
a first control circuit, such as for example any one or more of circuits 518, 519,570,571, or 575, within the first PMU, the first control circuit having a first semaphore generation circuit, such as for example circuit 570, that is configurable to count reception of data from the first data group to the first PMU as a first data count, such as for example the count in circuit 570, the first control circuit having a second semaphore generation circuit, such as for example circuit 571, that is configurable to count reception of data from the second data group to the first PMU as a second data count, such as for example count in circuit 571,;
a second control circuit, such as for example any one or more of circuits 514,515,560,561, or 565, within the second PMU, the second control circuit having a third semaphore generation circuit, such as for example circuit 560, that is configurable to send a first reception signal, such as for example signal 555, to the first semaphore generation circuit in response to the second control circuit detecting a reception from the first data group to the second PMU, the second control circuit having a fourth semaphore generation circuit, such as for example circuit 561, that is configurable to send a second reception signal, such as for example signal 556, to the second semaphore generation circuit in response to the second control circuit detecting a reception from the second data group to the second PMU;
the first semaphore generation circuit configured to change the first data count in response to receiving the first reception signal;
the second semaphore generation circuit configured to change the second data count in response to receiving the second reception signal, such as for example 556;
the first semaphore generation circuit configured to store a first target value, such as for example stored in set point circuit 816 of circuit 570, for the first data group, and the second semaphore generation circuit configured to store a second target value, such as for example stored in set point circuit 816 of circuit 571, for the second data group; and
the first control circuit configured to assert a first output signal, such as for example signal 591, in response to the first data count being substantially equal to the first target value and to assert a second output signal, such as for example signal 592, in response to the second data count being substantially equal to the second target value wherein the first control circuit inhibits asserting the second output signal until after the first data count is substantially equal to the first target value which inhibits the first destination CGRU from reading the second data group from both the first PMU and the second PMU.

An implementation of the CGR processor may include that the first control circuit may be configurable to either count reception of data from the first data group to a first memory store of the first PMU or to send a third reception signal, such as for example signal 591, to another PMU in response to reception of data from the first data group to the first memory store of the first PMU.

Another implementation may include that the second control circuit may be configurable to either count reception of data from the first data group to a first memory store of the second PMU, or to send the first reception signal to the first semaphore generation circuit, such as for example circuit 570.

In another implementation, the first PMU may be configured to receive at least a portion of the second data group before receiving all of the first data group, and inhibit asserting the second output signal until receiving all of the first data group.

An implementation may include that the first PMU may be configured to receive all of the second data group before completing reception of all of the first data group, and inhibit asserting the second output signal until receiving all of the first data group.

Another implementation may include that the first control circuit may include a configuration store, such as for example circuit 518, wherein the first target value and the second target value may be stored into the configuration store prior to the first PMU receiving any of the first data group or the second data group.

In another implementation, the first control circuit may be configured to store the first target value into the first semaphore generation circuit, and to store the second target value into the second semaphore generation circuit.

An implementation may include that the first control circuit may be configured to transmit the first output signal and the second output signal over a control bus of the array level network.

In an implementation, the first semaphore generation circuit may include an up/down counter that forms the first data count.

Another implementation may include that the first control circuit may be configured to compare contents of the up/down counter to the first target value.

In an implementation, the first destination CGRU may receive the first output signal and read the first data group from the first PMU and the second PMU in response to receiving an asserted state of the first output signal, and read the second data group from the first PMU and the second PMU in response to receiving an asserted state of the second output signal.

An implementation may include that the first PMU may include a first memory store, such as for example memory store 517, the first control circuit configured to partition the first memory store into N number of local buffer store areas, such as for example buffers 630-633, that correspond to N number of semaphore generation circuits of the first PMU.

Another implementation may include that one or more elements of the first data group that are received by the first PMU may be a data packet having a packet header and having a packet data wherein the packet header identifies the data packet.

Those skilled in the art will appreciate that an implementation of a coarse-grained reconfigurable (CGR) processor (CGRP) may comprise:
an array of CGR units (CGRUs) including a first group of PMUs and a second group of PMUs wherein the first group of PMUs and the second group of PMUs are configured to receive data from a first data group;
the first group of PMUs configured to assert a first output signal in response to receiving data from the first data group;
a first routing semaphore control circuit that is external to the first group of PMUs and external to the second group of PMUs, the first routing semaphore control circuit configured to receive the first output signal from the first group of PMUs and responsively assert a second output signal in response to the received first output signal;
the second group of PMUs configured to assert a third output signal in response to receiving data from the first data group;
a second routing semaphore control circuit that is external to the first group of PMUs and external to the second group of PMUs, the second routing semaphore control circuit configured to receive the third output signal from each of the second group of PMUs and responsively assert a fourth output signal in response to each received third output signal;
a final semaphore control circuit that is external to the first group of PMUs and external to the second group of PMUs, the final semaphore control circuit configured to receive the second output signal from the first routing semaphore control circuit and configured to receive the fourth output signal from the second routing semaphore control circuit; and
the final semaphore control circuit configured to count the second output signal as a first data count and to count the fourth output signal as a part of the first data count, the final semaphore control circuit having a final target value for the first data group wherein the final semaphore control circuit asserts a final output signal in response to the first data count being substantially the final target value.

An implementation may include that the first routing semaphore control circuit may include N number of inputs wherein a value of N is less than a total number of PMUs in the first group and the second group;
each PMU of the first group of PMUs has a first semaphore control circuit that is configured to assert the first output signal in response to receiving data from the first data group, the first semaphore control circuit having a first target value of one; and
each PMU of the second group of PMUs has a second semaphore control circuit that is configured to assert the third output signal in response to receiving data from the first data group, the second semaphore control circuit having a second target value of one.

Those skilled in the art will appreciate that an implementation of a method of sequencing a gathering of data stored in a memory store of a first configurable unit in an array of configurable units of a coarse grained reconfigurable processor, may comprise:
configuring the first configurable unit, such as for example PMU 509, to receive a first target value, such as for example the value in circuit 516 or 560, of data to be received in a first data group, such as for example group 910, and to receive a second target value, such as for example the value in circuit 516 or 561, of data to be received in a second data group, such as for example group 920;
configuring a first circuit, such as for example one or more of circuits CL515 or SCC514, of the first configurable unit to form a first data count, such as for example the count in circuit 560, that is representative of data received from the first data group by a first memory store, such as for example buffers 944, of the first configurable unit;
configuring the first circuit to change the first data count in response to a reception of data from the first data group by a second memory store, such as for example memory store 517, of a second configurable unit, such as for example PMU 510, in the array of configurable units; and
configuring the first circuit to inhibit reading data of the second data group from the first memory store and from the second memory store until after the first data count reaches the first target value.

An implementation may further include a first source configurable unit configured to send data to the first configurable unit, the first circuit configured to notify the first source configurable unit that the first data count has reached the first target value.

Another implementation may further include a first destination configurable unit, the first circuit configured to notify the first destination configurable unit that the first data count has reached the first target value.

In an implementation, the first circuit may be selectively configurable to either count data that is received by the first configurable unit or to receive signals from another configurable unit that receives the data and to count signals that are received.

An implementation of the method may further include configuring the first circuit to form a second data count, such as for example the count in circuit 561, that is representative of data received from the second data group by the first memory store of the first configurable unit, and configuring the first circuit to change the second data count in response to a reception of data from the second data group by the second memory store of the second configurable unit.

Those skilled in the art will appreciate that an implementation of a coarse-grained reconfigurable (CGR) processor (CGRP) may comprise:
an array, such as for example 400/500, of coarse-grained reconfigurable (CGR) units (CGRUs), such as for example 500, configured to communicate over an array level network;
the array of CGRUs including a first source CGRU, such as for example CGRU 503;
one or more first configurable units, such as for example PMUs 509-511, of the array of CGRUs wherein the one or more first configurable units are configurable to receive data of a first data group from the first source CGRU wherein the first data group is distributed among the one or more first configurable units;
a first control circuit, such as for example SCCs 514/614, configurable to detect the one or more first configurable units completing reception of all data of the first data group and to responsively notify one of the first source CGRU or another CGRU, such as for example destination CGRU 538/39, of the array of CGRUs.

Additionally, the first control circuit may be configured to receive a first target value representing a total amount of data in the first data group, the first control circuit configurable to detect reception of data by each of the one or more first configurable units.

An implementation may include that the first control circuit may receive a first target value representing a total amount of data in the first data group, the first control circuit configurable to count each reception of data by each of the one or more first configurable units.

Another implementation may include that the one or more first configurable units are configurable to also receive data of the first data group from a second source CGRU, such as for example CGRU 504, in addition to receiving data of the first data group from the first source CGRU.

Those skilled in the art will appreciate that an implementation of a non-transitory machine readable medium may comprise computer instructions that, in response to being executed by a processor, cause the processor to:
produce a configuration file, such as for example Cfg. 516/618, to specify a first target value of data in a first data group, such as for example data 910, and a second target value of data in a second data group;
configure a first circuit, such as for example circuit that includes 560,515,514, of a first configurable unit, such as for example PMU 509, to count reception of data, such as for example data 910, from the first data group to a first memory store, such as for example MS 513, of the first configurable unit, such as for example PMU 509, wherein the first circuit representatively forms a first data count;
configure a second circuit, such as for example SMG 561, of the first configurable unit, such as for example PMU 509, to count reception of data, such as for example 920, from a second data group to the first memory store, such as for example MS 513, of the first configurable unit wherein the second circuit representatively forms a second data count;
configure a third circuit, such as for example circuit that includes 570,518,519, of a second configurable unit, such as for example PMU 510, to send a first reception signal, such as for example signal 591, to the first circuit wherein the first reception signal is representative of reception of data from the first data group to a second memory store, such as for example MS 517, of the second configurable unit;
configure the first circuit to count the first reception signal, such as for example signal 591, as a part of the first data count in response to receiving the first reception signal; and
configure the first circuit to inhibit, such as for example signal 645, reading the second data group from the first memory store and the second memory store until transfers of the first data group reach the first target value.

Another implementation may include configuring the second configurable unit, such as for example PMU 510, to send a second reception signal, such as for example 592-94, to the first configurable unit, wherein the second reception signal, such as for example 592, is representative of reception of data from the second data group.

Additionally, an implementation may include configuring a first semaphore generation circuit, such as for example SMG 560, of the first circuit, such as for example CL 515/SCC 514, to count data that is received from the first data group by the first memory store, such as for example MS 513, and to count the first reception signal as a part of the first data count.

An implementation may include that the first circuit, such as for example circuit that includes 515,514, may be configurable to either count reception of data from the first data group as the first data count or to send a second reception signal, such as for example signal 555, to another configurable unit wherein the second reception signal is representative of reception of data from the first data group that is received by the first memory store.

Another implementation may include that the configuration file, such as for example file in Cfg 516, includes parameters to configure the first circuit, such as for example circuits 509,515,514, to count reception of data from the first data group.

Those skilled in the art will appreciate that an implementation of a method of sequencing gathering of data stored in a memory store of a first configurable unit in an array of configurable units of a coarse grained reconfigurable processor, may comprise: configuring the first configurable unit, such as for example PMU 509, to receive a first target value, such as for example value stored in 516/560, of data to be received in a first data group, such as for example data 944, and to receive a second target value, such as for example 516/561, of data to be received in a second data group, such as for example 920;
configuring a first circuit, such as for example circuit that includes CL 515/SCC514, of the first configurable unit, such as for example PMU 509, to form a first data count, such as for example SMG 560, that is representative of data received from the first data group by a first memory store, such as for example 944, of the first configurable unit;
configuring the first circuit to form a second data count, such as for example SMG 561, that is representative of data received from the second data group by the first memory store, such as for example 946, of the first configurable unit;
configuring the first circuit to change the first data count in response to a reception of data from the first data group by a second memory store, such as for example MS 517, of a second configurable unit, such as for example PMU 510, in the array of configurable units;
configuring the first circuit, such as for example SCC 514, to change the second data count in response to a reception of data from the second data group by the second memory store, such as for example MS 517, of the second configurable unit; and
configuring the first circuit to inhibit, such as for example signal 555/SCC 514, reading data of the second data group from the first memory store and from the second memory store until after the first data count reaches the first target value.

In view of all of the above, it is evident that a novel device and method is disclosed. Included, among other features, is configuring a PMU to selectively operate to inhibit reading of data written to the PMU until after all data of a data group is written into the PMU. A PMU may be selectively configured to operate in a master mode to count data written into the PMU or to operate in a secondary mode to not count the data written to the PMU and instead send reception signals via a networked control bus to a master PMU to indicate that the secondary PMU has received data. The master PMU may be selectively configured to count data of a data group that is written to the PMU and to also count the reception signals received via the networked control bus from a secondary PMU. The master PMU may use that count to determine if the data is ready to be read by a destination CGRU. Sequencing of the reading of the data assists in sequencing the data to be read in the order of the data groups, such as for example the sequence ID of the data, and assists in improving the system performance and minimizing software having to perform multiple searches for the data.

While the subject matter of the descriptions are described with specific implementations and example implementations, the foregoing drawings and descriptions thereof depict only typical and non-limiting examples of implementations of the subject matter and are not therefore to be considered to be limiting of its scope, it is evident that many alternatives and variations will be apparent to those skilled in the art. As will be appreciated by those skilled in the art, the example form of arrays 500 900 and 1000 are used as a vehicle to explain the operation method sequencing the reading of data written to a PMU. The CGRUs and PMUs may be configured with various other implementations in addition to the implementations illustrated in FIGS. 500 and 800-1000, such as for example other implementations of the SCC and SMP circuits as long as the reading of the data is sequenced to maintain the order of the data.

As the claims hereinafter reflect, inventive aspects may lie in less than all features of a single foregoing disclosed implementation(s). Thus, the hereinafter expressed claims are hereby expressly incorporated into this Detailed Description, with each claim standing on its own as a separate implementation of an implementation. Furthermore, while some implementations described herein include some but not other features included in other implementations, combinations of features of different implementations are meant to be within the scope of the claims and implementations, and form different implementations, as would be understood by those skilled in the art.

1. A coarse-grained reconfigurable (CGR) processor (CGRP) comprising:
an array of CGR units (CGRUs) including a first source CGRU, a first Pattern Memory Unit (PMU), a second Pattern Memory Unit (PMU), and a first destination CGRU wherein the array of CGRUs is configured to communicate over an array level network;
the first source CGRU configured to distribute a first data group among both the first PMU and the second PMU;
the first source CGRU configured to distribute a second data group among the first PMU and to the second PMU;
a first control circuit within the first PMU, the first control circuit having a first semaphore generation circuit that is configurable to count reception of data from the first data group to the first PMU as a first data count, the first control circuit having a second semaphore generation circuit that is configurable to count reception of data from the second data group to the first PMU as a second data count;
a second control circuit within the second PMU, the second control circuit having a third semaphore generation circuit that is configurable to send a first reception signal to the first semaphore generation circuit in response to the second control circuit detecting a reception from the first data group to the second PMU, the second control circuit having a fourth semaphore generation circuit that is configurable to send a second reception signal to the second semaphore generation circuit in response to the second control circuit detecting a reception from the second data group to the second PMU;
the first semaphore generation circuit configured to change the first data count in response to receiving the first reception signal;
the second semaphore generation circuit configured to change the second data count in response to receiving the second reception signal;
the first semaphore generation circuit configured to store a first target value for the first data group, and the second semaphore generation circuit configured to store a second target value for the second data group; and
the first control circuit configured to assert a first output signal in response to the first data count being substantially equal to the first target value and to assert a second output signal in response to the second data count being substantially equal to the second target value wherein the first control circuit inhibits asserting the second output signal until after the first data count is substantially equal to the first target value which inhibits the first destination CGRU from reading the second data group from both the first PMU and the second PMU.

2. The CGR processor of claim 1 wherein the first control circuit is configurable to either count reception of data from the first data group to a first memory store of the first PMU or to send a third reception signal to another PMU in response to reception of data from the first data group to the first memory store of the first PMU.

3. The CGR processor of claim 1 wherein the second control circuit is configurable to either count reception of data from the first data group to a first memory store of the second PMU or to send the first reception signal to the first semaphore generation circuit.

4. The CGR processor of claim 1 wherein the first PMU is configured to receive at least a portion of the second data group before receiving all of the first data group and inhibit asserting the second output signal until receiving all of the first data group.

5. The CGR processor of claim 1 wherein the first PMU is configured to receive all of the second data group before completing reception of all of the first data group and inhibit asserting the second output signal until receiving all of the first data group.

6. The CGR processor of claim 1 wherein the first control circuit includes a configuration store and wherein the first target value and the second target value are stored into the configuration store prior to the first PMU (510) receiving any of the first data group or the second data group.

7. The CGR processor of claim 6 wherein the first control circuit is configured to store the first target value into the first semaphore generation circuit, and to store the second target value into the second semaphore generation circuit.

8. The CGR processor of claim 1 wherein the first control circuit is configured to transmit the first output signal and the second output signal over a control bus of the array level network.

9. The CGR processor of claim 1 wherein the first semaphore generation circuit includes an up/down counter that forms the first data count.

10. The CGR processor of claim 9 wherein the first control circuit is configured to compare contents of the up/down counter to the first target value.

11. The CGR processor of claim 1 wherein the first destination CGRU receives the first output signal and reads the first data group from the first PMU and the second PMU in response to receiving an asserted state of the first output signal, and reads the second data group from the first PMU and the second PMU in response to receiving an asserted state of the second output signal.

12. The CGR processor of claim 1 wherein the first PMU includes a first memory store, the first control circuit configured to partition the first memory store into N number of local buffer store areas that correspond to N number of semaphore generation circuits of the first PMU.

13. The CGR processor of claim 1 wherein one or more elements of the first data group that are received by the first PMU are a data packet having a packet header and having a packet data wherein the packet header identifies the data packet.

14. A coarse-grained reconfigurable (CGR) processor (CGRP) comprising:
an array of CGR units (CGRUs) including a first group of PMUs and a second group of PMUs wherein the first group of PMUs and the second group of PMUs are configured to receive data from a first data group;
the first group of PMUs configured to assert a first output signal in response to receiving data from the first data group;
a first routing semaphore control circuit that is external to the first group of PMUs and external to the second group of PMUs, the first routing semaphore control circuit configured to receive the first output signal from the first group of PMUs and responsively assert a second output signal in response to the received first output signal;
the second group of PMUs configured to assert a third output signal in response to receiving data from the first data group;
a second routing semaphore control circuit that is external to the first group of PMUs and external to the second group of PMUs, the second routing semaphore control circuit configured to receive the third output signal from each of the second group of PMUs and responsively assert a fourth output signal in response to each received third output signal;
a final semaphore control circuit that is external to the first group of PMUs and external to the second group of PMUs, the final semaphore control circuit configured to receive the second output signal from the first routing semaphore control circuit and configured to receive the fourth output signal from the second routing semaphore control circuit; and
the final semaphore control circuit configured to count the second output signal as a first data count and to count the fourth output signal as a part of the first data count, the final semaphore control circuit having a final target value for the first data group wherein the final semaphore control circuit asserts a final output signal in response to the first data count being substantially the final target value.

15. The coarse-grained reconfigurable (CGR) processor (CGRP) of claim 14 wherein the first routing semaphore control circuit includes a N number of inputs wherein a value of N is less than a total number of PMUs in the first group and the second group;
each PMU of the first group of PMUs has a first semaphore control circuit that is configured to assert the first output signal in response to receiving data from the first data group, the first semaphore control circuit having a first target value of one; and
each PMU of the second group of PMUs has a second semaphore control circuit that is configured to assert the third output signal in response to receiving data from the first data group, the second semaphore control circuit having a second target value of one.

16. A method of sequencing a gathering of data stored in a memory store of a first configurable unit in an array of configurable units of a coarse grained reconfigurable processor, the method comprising:
configuring the first configurable unit to receive a first target value of data to be received in a first data group and to receive a second target value of data to be received in a second data group;
configuring a first circuit of the first configurable unit to form a first data count that is representative of data received from the first data group by a first memory store of the first configurable unit;
configuring the first circuit to change the first data count in response to a reception of data from the first data group by a second memory store of a second configurable unit in the array of configurable units; and
configuring the first circuit to inhibit reading data of the second data group from the first memory store and from the second memory store until after the first data count reaches the first target value.

17. The method of claim 16 further including a first source configurable unit configured to send data to the first configurable unit, the first circuit configured to notify the first source configurable unit that the first data count has reached the first target value.

18. The method of claim 16 further including a first destination configurable unit, the first circuit configured to notify the first destination configurable unit that the first data count has reached the first target value.

19. The method of claim 16 wherein the first circuit is selectively configurable to either count data that is received by the first configurable unit or to receive signals from another configurable unit that receives the data and to count signals that are received.

20. The method of claim 19 further including configuring the first circuit to form a second data count that is representative of data received from the second data group by the first memory store of the first configurable unit, and configuring the first circuit to change the second data count in response to a reception of data from the second data group by the second memory store of the second configurable unit.
